(19) United States
(12) Patent Application Publication
(10) Pub. No.: US 2023/0182406 A1
(43) Pub. Date: Jun. 15, 2023

(54) COMPOSITE MATERIAL AND METHOD FOR PRODUCING MOLDED ARTICLE

(71) Applicant: TEIJIN LIMITED, Osaka (JP)

(72) Inventors: Shuhei SUZUKI, Osaka (JP); Hodaka YOKOMIZO, Osaka (JP); Tetsuya YONEDA, Osaka (JP); Takumi KATO, Osaka (JP); YUKI SAIONJI, Osaka (JP); Yuki SAIONJI, Osaka (JP)

(73) Assignee: TEIJIN LIMITED, Osaka (JP)

(21) Appl. No.: 18/163,599

(22) Filed: Feb. 2, 2023

Related U.S. Application Data
(63) Continuation of application No. PCT/JP21/27983, filed on Jul. 28, 2021.

(30) Foreign Application Priority Data
Aug. 4, 2020 (JP) 2020-132326

(51) Int. Cl. B29C 70/12

(52) U.S. Cl. CPC B29C 70/12; B29K 2307/04

(57) ABSTRACT

A composite material containing reinforcing fibers A and a matrix resin, the reinforcing fibers A being discontinuous fibers having a fiber length of at least 5 mm and containing reinforcing fibers A1 having a bundle width of less than 0.3 mm and a reinforcing fiber bundle A2 having a fiber width of 0.3-3.0 mm, inclusive, wherein the coefficient of variation CVi_{A2} of Vfi_{A2} is 35% or less in at least a minimum bundle width zone (i=1) and a maximum bundle width zone (i=n) when the reinforcing fiber bundle A2 is divided into a pre-set plurality of bundle width zones (total number of bundle width zones n≥3) and the volume ratio of the reinforcing fiber bundle A2 in each bundle width zone is Vfi_{A2}. Also, a method for producing a molded article which uses the composite material.

### CROSS REFERENCE TO RELATED APPLICATION

This is a continuation-in-part application of International Application No. PCT/JP2021/027983 filed on Jul. 28, 2021, and claims priorities from Japanese Patent Application No. 2020-132326 filed on Aug. 4, 2020.

### TECHNICAL FIELD

The present invention relates to a composite material containing discontinuous fibers and a matrix resin, and a method for producing a molded article using the same in which a bundle distribution of reinforcing fibers is adjusted to a desired distribution.

### BACKGROUND ART

In recent years, composite materials have been attracting attention as structural members for automobiles and the like due to their excellent mechanical properties.

Patent Literature 1 describes a composite material using two types of reinforcing fibers having different lengths and a thermoplastic resin. Patent Literature 2 describes improving the appearance of the molded article after molding by suppressing unevenness in shape and mechanical properties during molding with a small pitch. Patent Literature 3 provides a molded article that achieves both mechanical properties and moldability by not bending discontinuous thin bundles of carbon fibers. Patent Literature 4 describes a random mat containing reinforcing fibers having an average fiber length of 3 to 100 mm and a thermoplastic resin, and having an average fiber width distribution ratio (Ww/Wn) of 1.00 or more and 2.00 or less.

### CITATION LIST

### Patent Literature

Patent Literature 1: JPH10 (1998)-323829
Patent Literature 2: WO2016/152563 Pamphlet
Patent Literature 3: WO2019/107247 pamphlet
Patent Literature 4: WO2014/021316 Pamphlet

### SUMMARY

### Technical Problem

However, the composite material described in Patent Literature 1 uses reinforcing fibers of two different lengths (eg, 25 mm and 3 mm), but the fiber bundle width is too large (eg, 15 mm wide). If a reinforcing fiber with a fiber bundle width that is too large is used, not only the strength of the fiber bundle cannot be sufficiently exhibited because the aspect ratio of the fiber bundle is too small, but also destruction occurs starting from the resin because the sea of resin called a resin pocket is too wide. In addition, since the fiber bundle widths described in Patent Literature 1 are all the same length, there is no distribution of the fiber bundle widths, and resin pockets are likely to occur between the fiber bundles.

In the composite material described in Patent Literature 2, although the unevenness in basis weight is improved, the uniformity of the fiber bundle width is still insufficient, and there is a need to further improve the shapeability of the composite material.

The invention described in Patent Literature 3 has a bundle width section of 0.3 to 3.0 mm, and since the bundle width is a fixed length, there is no concept of making each bundle width uniform. Therefore, it is required to improve the transportability of the composite material (the transportability of the composite material after heating when the matrix resin is a thermoplastic matrix resin).

Patent Literature 4 describes that the random mat has an average fiber width distribution ratio (Ww/Wn) of 1.00 or more and 2.00 or less, which means that the fiber distribution has a uniform peak. There is no point of view that is the same distribution no matter where the fibers are sampled.

Accordingly, an object of the present invention is to provide a composite material that achieves both higher mechanical properties and moldability, and further improves shapeability during molding.

### Solution to Problem

In order to solve the above problems, the present invention provides the following means.

1. A composite material comprising reinforcing fibers A and a matrix resin, wherein:

the reinforcing fibers A are discontinuous fibers having a fiber length of 5 mm or more;

the reinforcing fibers A comprise
reinforcing fibers A1 having a fiber width of less than 0.3 mm; and

reinforcing fiber bundles A2 having a bundle width of 0.3 mm or more and 3.0 mm or less,

when the reinforcing fiber bundles A2 are divided into a plurality of predetermined bundle width zones (the total number n of bundle width zones satisfies n≥3), and when the volume fraction of the reinforcing fiber bundles A2 in each bundle width zone is Vfi_{A2}, coefficient of variation CVi_{A2} of Vfi_{A2} is 35% or less in at least the minimum bundle width zone (i=1), and the maximum bundle width zone (i=n),

wherein the coefficient of variation CVi_{A2} of Vfi_{A2} is calculated by the formula (a):

coefficient of variation CVi_{A2}=100×standard deviation of Vfi_{A2}/average of Vfi_{A2} formula (a).

2. The composite material according to 1 above,

wherein the coefficients of variation CVi_{A2} of Vfi_{A2} in all bundle width zones (i=1, . . . , n) are 35% or less.

3. The composite material according to 1 or 2 above,

wherein the coefficient of variation CV_{A1} of Vf_{A1} is 35% or less, where Vf_{A1} is the volume fraction of the reinforcing fibers A1,

wherein the coefficient of variation CV_{A1} of Vf_{A1} is calculated by formula (b):

coefficient variation CV_{A1}=100×standard deviation of Vf_{A1}/average of Vf_{A1} formula (b).

4. The composite material according to any one of 1 to 3 above,

wherein the reinforcing fibers A are carbon fibers.

5. The composite material according to any one of 1 to 4 above,

wherein the matrix resin is a thermoplastic matrix resin.

6. The composite material according to any one of 1 to 5 above,

wherein the matrix resin is a thermoplastic matrix resin, and

springback amount of the composite material is more than 1.0, wherein the spring back amount is a ratio of a thickness of the composite material after preheating to a thickness of the composite material before preheating, and

coefficient of variation CVs of springback amount is less than 35%, wherein the coefficient of variation CVs is calculated by the formula (c):

coefficient of variation CVs=100×standard deviation of springback amount/average of springback amount formula (c).

7. The composite material according to any one of 1 to 6 above, comprising reinforcing fibers B having a fiber length of less than 5 mm.

8. A method for producing a molded article, comprising cold-pressing the composite material according to any one of 1 to 7 above to produce a molded article.

9. The composite material according to any one of 1 to 7 above,

wherein the total number of bundle width zones n is 9, and

each bundle width zone is followings:

| | |
|---|---|
| bundle width zone (i = 1) | 0.3 mm ≤ bundle width < 0.6 mm |
| bundle width zone (i = 2) | 0.6 mm ≤ bundle width < 0.9 mm |
| bundle width zone (i = 3) | 0.9 mm ≤ bundle width < 1.2 mm |
| bundle width zone (i = 4) | 1.2 mm ≤ bundle width < 1.5 mm |
| bundle width zone (i = 5) | 1.5 mm ≤ bundle width < 1.8 mm |
| bundle width zone (i = 6) | 1.8 mm ≤ bundle width < 2.1 mm |
| bundle width zone (i = 7) | 2.1 mm ≤ bundle width < 2.4 mm |
| bundle width zone (i = 8) | 2.4 mm ≤ bundle width < 2.7 mm |
| bundle width zone (i = 9) | 2.7 mm ≤ bundle width ≤ 3.0 mm. |

10. The composite material according to 9 above, wherein

the following formulas (x), (y) and (z) are satisfied, where Vfi_{A2} is the volume fraction of the reinforcing fiber bundles A2 in each bundle width zone.

0≤Vf(i=1)_{A2}<10% formula (x)

0<Vfi_{A2} is satisfied in two or more bundle width zones of i=2 to 9 formula (y)

Vf(i=1)_{A2}<Vf(i=at least one of 2 to 9)_{A2}. formula (z)

### Advantageous Effects of Invention

Since the reinforcing fibers contained in the composite material designed according to the present invention have a uniform bundle width, the drape property of the composite material is stable when heated.

Further, in particular, when a thermoplastic matrix resin is used as the resin, the pre-shaping property is stabilized when the composite material is placed on the mold. Moreover, since the heating time can be shortened when the composite material is heated, the reduction of the molecular weight in the molded article can be suppressed.

Furthermore, when manufacturing a composite material, it is possible to uniformly impregnate the reinforcing fibers with the matrix resin and shorten the impregnation time.

### BRIEF DESCRIPTION OF DRAWINGS

FIG. 1A describes a uniform distribution of fiber bundles sampled from a point with an air volume of 80 L/min.

FIG. 1B describes a uniform distribution of fiber bundles sampled from a location with an air volume of 120 L/min.

FIG. 1C describes a uniform distribution of fiber bundles sampled from a location with an air volume of 160 L/min.

FIG. 2A describes an uneven distribution of fiber bundles sampled from a point with an air volume of 80 L/min.

FIG. 2B describes an uneven distribution of fiber bundles sampled from a location with an air volume of 120 L/min.

FIG. 2C describes an uneven distribution of fiber bundles sampled from a location with an air volume of 160 L/min.

FIG. 3A is a schematic diagram when the composite material is heated and the drape property is evaluated.

FIG. 3B is a schematic diagram when the composite material is heated and the drape property is evaluated.

FIG. 3C is a schematic diagram when the composite material is heated and the drape property is evaluated.

FIG. 3D is a schematic diagram when the composite material is heated and the drape property is evaluated.

FIG. 4 is a schematic diagram of fiber separation by pressing against a receiving roller.

FIG. 5 is a schematic diagram of separating a reinforcing fiber bundle by a shear blade method.

FIG. 6 is a schematic diagram of separating reinforcing fiber bundles by a gang type slit method.

FIG. 7 is a schematic diagram of a slit device.

FIG. 8 is a schematic diagram of slitting the reinforcing fiber bundle by inserting and removing the blade.

FIG. 9 is a schematic diagram depicting a composite material sagging under its own weight after being heated.

FIG. 10A is a schematic diagram showing how a molded article provided with a hole is manufactured at the same time as molding.

FIG. 10B is a schematic diagram showing how a molded article provided with a hole is manufactured at the same time as molding.

FIG. 10C is a schematic diagram showing how a molded article provided with a hole is manufactured at the same time as molding.

FIG. 10D is a schematic diagram showing how a molded article provided with a hole is manufactured at the same time as molding.

FIG. 11A is a schematic diagram showing how a molded article provided with two holes is manufactured at the same time as molding.

FIG. 11B is a schematic diagram showing how a molded article provided with two holes is manufactured at the same time as molding.

FIG. 11C is a schematic diagram showing how a molded article provided with two holes is manufactured at the same time as molding.

FIG. 12A is an analysis result of the composite material obtained in Example 5 in which the fiber bundle distribution is partially missing.

FIG. 12B is an analysis results of the composite material obtained in Example 6.

FIG. 13A is an analysis result of the composite material of Example 7, in which the fiber width distribution is partially missing.

FIG. 13B is an analysis result of the composite material of Example 7, in which the fiber width distribution is partially missing.

FIG. 13C is an analysis result of the composite material of Example 7, in which the fiber width distribution is partially missing.

### DESCRIPTION OF EMBODIMENTS

### [Reinforcing Fiber]

The reinforcing fibers used in the present invention are not particularly limited, but are preferably one or more reinforcing fibers selected from the group consisting of carbon fibers, glass fibers, aramid fibers, boron fibers, and basalt fibers.

### [Carbon Fiber]

The reinforcing fibers of the present invention are preferably carbon fibers. As carbon fibers, polyacrylonitrile (PAN)-based carbon fibers, petroleum/coal pitch-based carbon fibers, rayon-based carbon fibers, cellulose-based carbon fibers, lignin-based carbon fibers, phenol-based carbon fibers, and the like are generally known. Any of these carbon fibers can be suitably used in the present invention. Among them, polyacrylonitrile (PAN)-based carbon fibers are preferably used in the present invention because of their excellent tensile strength.

### [Fiber Diameter of Carbon Fiber]

The fiber diameter of the carbon fiber monofilament (generally, the monofilament may be called a filament) used in the present invention may be appropriately determined according to the type of carbon fiber, and is not particularly limited. The average fiber diameter is generally preferably in the range of 3 μm to 50 μm, more preferably in the range of 4 μm to 12 μm, even more preferably in the range of 5 μm to 8 μm. When the carbon fiber is in the form of a fiber bundle, “fiber diameter” does not refer to the diameter of the fiber bundle, but refers to a diameter of the carbon fiber (monofilament) forming the fiber bundle. The average fiber diameter of carbon fibers can be measured, for example, by the method described in JIS R-7607:2000.

### [Sizing Agent]

The reinforcing fiber used in the present invention may have a sizing agent attached to its surface. When reinforcing fibers to which a sizing agent is attached are used, the type of the sizing agent can be appropriately selected according to the types of the reinforcing fibers and the matrix resin, and is not particularly limited.

### [Reinforcing Fiber A]

### [Weight Average Fiber Length of Reinforcing Fiber A]

The reinforcing fibers A are discontinuous fibers having a fiber length of 5 mm or more. The weight average fiber length of the reinforcing fibers A used in the present invention is not particularly limited, but the weight average fiber length is preferably 5 mm or more and 100 mm or less. The weight average fiber length of the reinforcing fibers A is more preferably 5 mm or more and 80 mm or less, and further preferably 10 mm or more and 60 mm or less. When the weight-average fiber length of the reinforcing fibers A is 100 mm or less, the fluidity of the composite material is improved, and a desired molded article shape can be easily obtained during press molding. On the other hand, when the weight average fiber length is 5 mm or more, the mechanical strength of the composite material tends to be improved.

In the present invention, reinforcing fibers A having different fiber lengths may be used together. In other words, the reinforcing fibers used in the present invention may have a single peak in the weight average fiber length, or may have a plurality of peaks.

The average fiber length of the reinforcing fiber A can be obtained, for example, by measuring the fiber length of 100 fibers randomly extracted from the composite material in units of 1 mm using a vernier caliper, and calculating the following formula (1). The average fiber length is measured by weight average fiber length (Lw).

The number average fiber length (Ln) and the weight average fiber length (Lw) are determined by the following formulas (1) and (2), where Li is the fiber length of each reinforcing fiber and j is the number of measured fibers.

Ln=ΣLi/j Expression (1)

Lw=(ΣLi²)/(ΣLi) Formula (2)

When the fiber length is constant, the number average fiber length and the weight average fiber length are the same.

Extraction of reinforcing fibers from a composite material can be performed, for example, by heat-treating the composite material at 500° C. for about 1 hour and removing the resin in a furnace.

### [Volume Fraction of Reinforcing Fibers Contained in Composite Material]

### 1. Total

There is no particular limitation on the reinforcing fiber volume fraction (hereinafter sometimes referred to as “Vfₜₒₜₐₗ” in this specification) contained in the composite material defined by the following formula (3), but the reinforcing fiber volume fraction (Vfₜₒₜₐₗ) is preferably 10 to 60 Vol %, more preferably 20 to 50 Vol %, and even more preferably 25 to 45 Vol %.

Reinforcing fiber volume fraction (Vfₜₒₜₐₗ)=100×reinforcing fiber volume/(reinforcing fiber volume+matrix resin volume) Formula (3)

When the reinforcing fiber volume fraction (Vfₜₒₜₐₗ) in the composite material is 10 vol % or more, desired mechanical properties are likely to be obtained. On the other hand, when the reinforcing fiber volume fraction (Vfₜₒₜₐₗ) in the composite material does not exceed 60 vol %, the fluidity when used for press molding or the like is good, and the desired molded article shape can be easily obtained.

The total of reinforcing fiber volume fraction (Vfₜₒₜₐₗ) contained in the composite material (or molded article) is the total value of the volume fractions of the reinforcing fibers A (reinforcing fiber A1, reinforcing fiber bundle A2, reinforcing fiber bundle A3) and reinforcing fiber B and the like. Vfₜₒₜₐₗ is the volume fraction of the total amount of reinforcing fibers contained in the composite material.

### 2. Each Volume Fractions

The volume fractions of the reinforcing fiber A1, the reinforcing fiber bundle A2 (the total reinforcing fiber A2 obtained by summing each bundle width zone), and the reinforcing fiber bundle A3 contained in the composite material are defined by the formulas (3-1), (3-2), and (3-3), respectively. The “volume of reinforcing fiber” in the denominator means the volume of all reinforcing fibers contained in the composite material.

Reinforcing fiber volume fraction(Vf_{A1})=100×volume of reinforcing fiber A1/(volume of reinforcing fiber+volume of matrix resin) Formula (3-1):

Reinforcing fiber volume fraction(Vf_{A2(total)})=100×volume of reinforcing fiber bundle A2/(reinforcing fiber volume+matrix resin volume) Formula (3-2):

Reinforcing fiber volume fraction(Vf_{A3})=100×volume of reinforcing fiber bundle A3/(reinforcing fiber volume+matrix resin volume) Formula (3-3):

[Volume Fraction of Reinforcing Fiber Bundle A2 in Bundle Width Zone (i=k)]

Volume fraction (Vf(i=k)_{A2}) of reinforcing fiber bundle A2 in bundle width zone (i=k) is obtained by the formula (3-4).

Reinforcing fiber volume fraction (Vf(i=k)_{A2})=100×volume of reinforcing fiber bundle A2 in bundle width zone (i=k)/(reinforcing fiber volume+matrix resin volume) Formula (3-4):

In addition, since it is common to measure the weight when actually measuring, the volume fraction of the reinforcing fiber bundle A2 (Vf(i=k)_{A2}) can be determined by formula (3-5) using the density of the reinforcing fiber (ρ_{cf}).

Vf(i=k)_{A2}=Reinforcing fiber volume fraction (Vfₜₒₜₐₗ)×(total weight of reinforcing fiber bundle A2 in bundle width zone (i=k)/ρ_{cf})×100/(weight of all reinforcing fibers/ρ_{cf}) Formula (3-5):

### [Reinforcing Fiber A1]

The reinforcing fibers A include reinforcing fibers A1 having a bundle width of less than 0.3 mm.

The reinforcing fibers A1 have a fiber width of less than 0.3 mm and therefore have a large aspect ratio. When the reinforcing fiber A1 is included, the mechanical properties are improved, and the composite material is easily stretched when the composite material is melted, making it easier to pre-shape in a mold. Therefore, the reinforcing fibers A preferably contains a small amount of reinforcing fiber A1.

### [Proportion of Reinforcing Fiber A1]

Volume fraction (Vf_{A1}) of the reinforcing fibers A1 is preferably more than 0 Vol % and 50 Vol % or less, more preferably 1 Vol % or more and 30 Vol % or less, still more preferably 1 Vol % or more and 20 Vol % or less, still further preferably 1 Vol %. % or more and 15 Vol % or less.

[Coefficient of Variation CV_{A1} of Vf_{A1}]

Here, when the volume fraction of the reinforcing fibers A1 is Vf_{A1}, the coefficient of variation CV_{A1} of Vf_{A1} is preferably 35% or less.

The coefficient of variation CV_{A1} of Vf_{A1} is calculated by the formula (b).

Coefficient of variation CV_{A1}=100×standard deviation of Vf_{A1}/average of Vf_{A1} formula (b)

At this time, it is preferable to divide the composite material into 100 mm×100 mm pitches, collect 10 samples, measure Vf_{A1} of each sample, and calculate the coefficient of variation.

When measuring a composite material, it is preferable to measure at a pitch of 100 mm×100 mm, but the size of the composite material or molded article may be small, and only one sample may be collected from one composite material or molded article even sampling is attempted at a pitch of 100 mm×100 mm. In this case, 10 composite materials or molded articles may be prepared, one sample may be taken from each of these 10 molded articles, and the coefficient of variation of 10 samples (10 pieces) may be calculated. Further, in the case where a composite material or a molded article has a planar body having a dimension of 1000 mm×100 mm, CVs is obtained by dividing the planar body into 10 samples and defined by coefficient of variations of values measured at 10 locations.

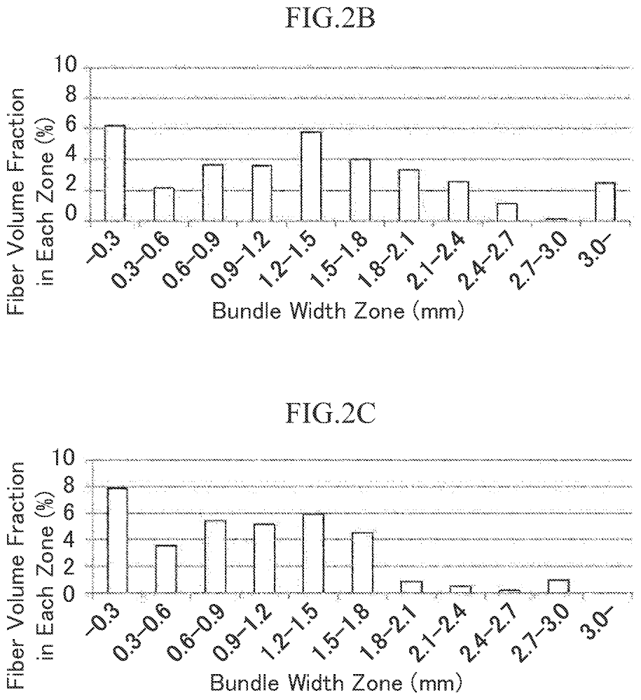

When the coefficient of variation CV_{A1} of Vf_{A1} is 35% or less, the sag when the composite material is heated becomes a uniform straight line as shown in FIG. 3A, for example. Therefore, if the coefficient of variation CV_{A1} of Vf_{A1} is 35% or less, the shaped shape is stabilized and the production efficiency is improved. On the other hand, when the coefficient of variation CV_{A1} of Vf_{A1} exceeds 35%, as shown in FIGS. 3B, 3C and 3D, the sag when the composite material is heated becomes uneven. The method for evaluating drape properties will be described later.

The coefficient of variation CV_{A1} of Vf_{A1} is preferably 30% or less, more preferably 25% or less, still more preferably 20% or less, and even more preferably 15% or less.

### [Reinforcing Fiber Bundle A2]

The reinforcing fibers A of the present invention include reinforcing fiber bundles A2 having a bundle width of 0.3 mm or more and 3.0 mm or less. Reinforcing fibers A having a fiber bundle width of less than 0.3 mm or having a fiber bundle width of more than 3.0 mm are reinforcing fibers A that are not reinforcing fiber bundles A2 in the present invention.

### [Bundle Width Zone of Reinforcing Fiber Bundle A2]

When the reinforcing fiber bundle A2 is divided into a plurality of predetermined bundle width zones (the total number n of bundle width zones satisfies n≥3), and the volume fraction of the reinforcing fiber bundle A2 in each bundle width zone is Vfi_{A2}, coefficient of variation CVi_{A2} of Vfi_{A2} is 35% or less in at least the minimum bundle width zone (i=1), and the maximum bundle width zone (i=n).

The bundle width zone refers to zones obtained by dividing a bundle width of 0.3 mm or more and 3.0 mm or less by fiber width so that the total number n is at least 3 or more.

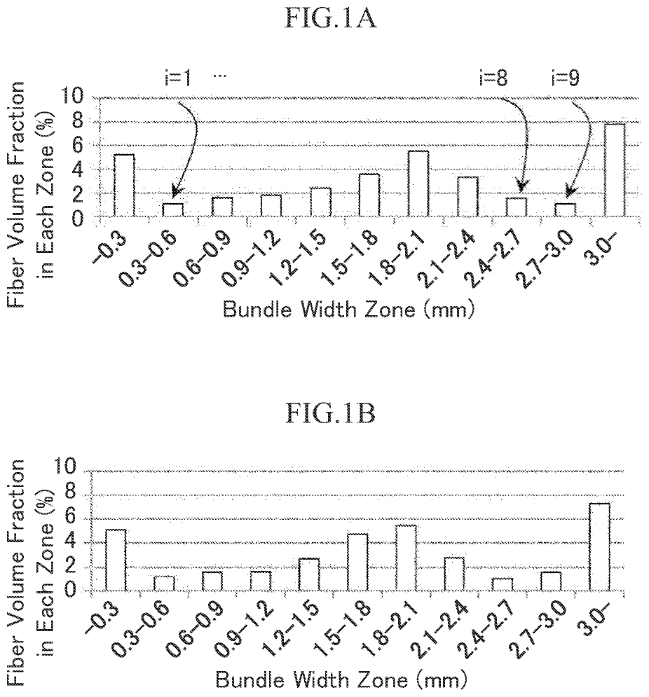

The plurality of predetermined bundle width zones refers to each zone on the horizontal axis drawn in FIG. 1A, for example. In FIG. 1A, the carbon fiber bundle A2 with a bundle width of 0.3 mm or more and 3.0 mm or less is divided into nine zones, i=1 is a zone with a bundle width of 0.3 mm or more and less than 0.6 mm, and i=9 is a zone with a bundle width of 2.7 mm or more and 3.0 mm or less.

In the composite material according to the present invention, the total number n of the bundle width zones is preferably in the range of 3 or more and 18 or less. That is, when the total number n of bundle width zones is 3, the bundle width of 0.3 mm or more and 3 mm or less is divided into three bundle width zones of 0.9 mm each. When the total number n of bundle width zones is 18, a bundle width of 0.3 mm or more and 3 mm or less is divided into 18 bundle width zones of 0.15 mm each.

If the total number n of bundle width zones is within this range, the distribution curve of the volume fraction of the reinforcing fiber bundle A2 can be clearly determined in each bundle width zone described above.

The total number n of bundle width zones may be 3 or more. Especially, when the total number n of bundle width zones is 9, it is possible to divide into 9 bundle width zones, and the range of each bundle width zone becomes clearer, the overall gradient can be clearly determined, and the implementation of the present invention is facilitated.

When the total number n of bundle width zones is 9, each bundle width zone is followings:

| | |
|---|---|
| Bundle width zone (i = 1) | 0.3 mm ≤ bundle width < 0.6 mm |
| Bundle width zone (i = 2) | 0.6 mm ≤ bundle width < 0.9 mm |
| Bundle width zone (i = 3) | 0.9 mm ≤ bundle width < 1.2 mm |
| Bundle width zone (i = 4) | 1.2 mm ≤ bundle width < 1.5 mm |
| Bundle width zone (i = 5) | 1.5 mm ≤ bundle width < 1.8 mm |
| Bundle width zone (i = 6) | 1.8 mm ≤ bundle width < 2.1 mm |
| Bundle width zone (i = 7) | 2.1 mm ≤ bundle width < 2.4 mm |
| Bundle width zone (i = 8) | 2.4 mm ≤ bundle width < 2.7 mm |
| Bundle width zone (i = 9) | 2.7 mm ≤ bundle width ≤ 3.0 mm |

The minimum bundle width zone (i=1) is a zone with the smallest bundle width among the divided bundle width zones, for example, a bundle width zone (i=1) of 0.3 mm or more and less than 0.6 mm in FIG. 1A.

Conversely, the maximum bundle width zone (i=n) is the zone with the maximum bundle width among the divided bundle width zones, for example, a bundle width zone (i=9) of 2.7 mm or more and 3.0 mm in FIG. 1A.

[Coefficient of Variation CVi_{A2} of Vfi_{A2} in Each Bundle Width Zone]

The coefficient of variation CVi_{A2} of the volume fraction Vfi_{A2} of the reinforcing fiber bundles A2 in each bundle width zone is calculated by the formula (a).

Coefficient of variation CVi_{A2}=100×standard deviation of Vfi_{A2}/average of Vfi_{A2} formula (a)

It is preferable to divide the composite material at a pitch of 100 mm×100 mm and measure each Vfi_{A2}. For example, in the case where a composite material has a planar body having a dimension of 1000 mm×100 mm, the coefficient of variation is defined by coefficient of variations obtained by dividing the planar body into 10 samples and measuring at 10 locations. When measuring a composite material, it is preferable to measure at a pitch of 100 mm×100 mm, but the size of the composite material or molded article may be small, and only one sample may be collected from one composite material or molded article even sampling is attempted at a pitch of 100 mm×100 mm. In this case, 10 composite materials or molded articles may be prepared, one sample is taken from each of these 10 molded articles, and the coefficient of variation of 10 samples (10 pieces) is calculated.

In the present invention, the coefficient of variation CVi_{A2} of Vfi_{A2} is 35% or less in at least the minimum bundle width zone (i=1) and the maximum bundle width zone (i=n).

In general, when widening a fiber bundle, a fluid is passed through the bundle or the tension is controlled in order to widen the bundle to a desired bundle width (for example, a uniform bundle width). In the past, when the reinforcing fibers were cut with a rotary cutter after widening, there was a problem that the reinforcing fibers were caught in (adhered to and could not be removed from) the cutter or roller. When airflow is used to detach the caught reinforcing fibers, the airflow is not constant in the TD direction or with the passage of time, and especially the value of the coefficient of variation CVI_{A2} becomes large in the minimum bundle width zone (i=1) and in the maximum bundle width zone (i=n).

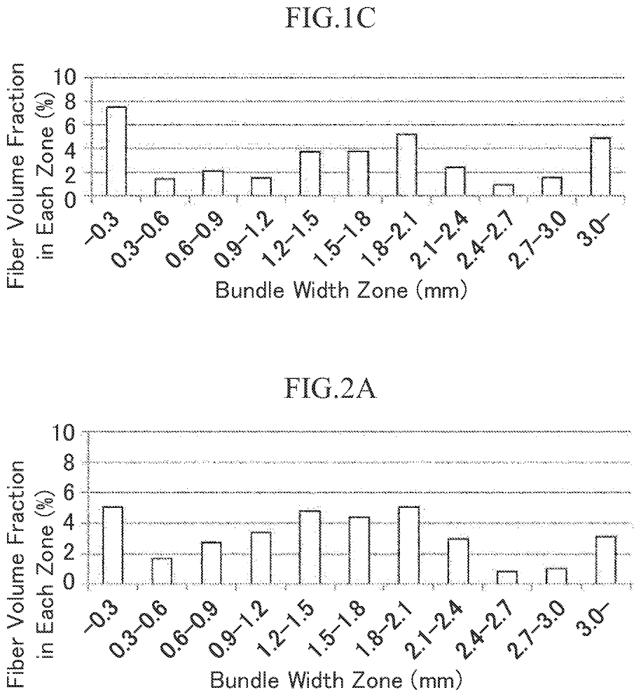

For example, FIG. 2A to 2C describe a fiber bundle distribution in a range of 0.3 mm to 3.0 mm in bundle width when an air current is used so that the reinforcing fibers do not get caught in the cutter or roller when cutting the reinforcing fiber using a rotary cutter after widening the reinforcing fiber bundle and the caught reinforcing fibers are removed. In FIGS. 2A to 2C, samples were taken from locations at air volumes of 80 L/min, 120 L/min and 160 L/min, respectively. As shown in FIGS. 2A to 2C, the lack of any control results in an uneven bundle distribution (in other words, a coefficient of variation in a particular bundle width zone is large).

Note that the bundle distribution may show one peak, or the bundle distribution may be broad, and the shape of the bundle distribution is not particularly limited. However, “uniform” here means that the distribution shape is uniform regardless of the sampling location.

In the composite material of the present application, coefficient of variation CVi_{A2} of Vfi_{A2} is preferably 35% or less in all bundle width zones (i=1, . . . , n). If the reinforcing fiber bundles A2 are made uniform in all the bundle width zones, it is possible to further improve the drape property during molding.

The coefficient of variation CVi_{A2} of Vfi_{A2} is preferably 30% or less, more preferably 25% or less, in all bundle width zones (i=1, . . . , n).

### [Average Bundle Width W_{A2} of Reinforcing Fiber Bundle A2]

In the present invention, the average bundle width W_{A2} of the reinforcing fiber bundles A2 is not particularly limited, but is preferably 1.0 mm or more and 2.5 mm or less. The average bundle width W_{A2} is the average of those with a bundle width of 0.3 mm or more and 3.0 mm or less.

Lower limit of the average bundle width W_{A2} is more preferably 1.8 mm or more.

Upper limit of the average bundle width W_{A2} is more preferably less than 2.5 mm, still more preferably less than 2.3 mm, and even more preferably 2.1 mm or less.

Further, when the average bundle width W_{A2} is less than 2.5 mm, the aspect ratio of the carbon fiber bundles becomes large, and the high strength of the carbon fiber bundles can be sufficiently exhibited in the composite material.

On the other hand, the lower limit of the average bundle width W_{A2} is more preferably 1.0 mm or more. When the thickness is 1.0 mm or more, the impregnating property is improved without excessively densifying the aggregate of reinforcing fibers.

### [Preferred Distribution Shape of Bundle Width Zone]

When the reinforcing fiber bundles A2 are divided into bundle width zones (i=1 to 9), it is preferable that the composite material satisfies the following formulas (x), (y) and (z), in which the volume fraction of the reinforcing fiber bundle A2 in each bundle width zone is Vfi_{A2}:

0≤Vf(i=1)_{A2}<10% Formula (x)

0<Vfi_{A2} is satisfied in two or more bundle width zones of i=2 to 9 Formula (y)

Vf(i=1)_{A2}<Vf(i=at least one of 2 to 9)_{A2} Formula (z)

Here, the bundle width zones are described below:

Bundle width zone (i=1) 0.3 mm≤bundle width<0.6 mm

Bundle width zone (i=2) 0.6 mm≤bundle width<0.9 mm

Bundle width zone (i=3) 0.9 mm≤bundle width<1.2 mm

Bundle width zone (i=4) 1.2 mm≤bundle width<1.5 mm

Bundle width zone (i=5) 1.5 mm≤bundle width<1.8 mm

Bundle width zone (i=6) 1.8 mm≤bundle width<2.1 mm

Bundle width zone (i=7) 2.1 mm≤bundle width<2.4 mm

Bundle width zone (i=8) 2.4 mm≤bundle width<2.7 mm

Bundle width zone (i=9) 2.7 mm≤bundle width≤3.0 mm

In Formula (x), more preferably 0≤Vf(i=1)_{A2}<5% is satisfied.

In Formula (y), more preferably 0<Vfi_{A2} is satisfied in three or more bundle width zones of i=2 to 9, still more preferably 0<Vfi_{A2} is satisfied in four or more bundle width zones, still further preferably 0<Vfi_{A2} is satisfied in 5 or more bundle width zones.

It is more preferable to satisfy at least one of the following formulas (z2), (z3), (z4), (z5), (z6) and (z7) in addition to formula (z). It is even more preferable to satisfy the following formulas (z2) and (z3), still further preferable to satisfy the following formulas (z4) and (z5), and most preferable to satisfy the following formulas (z6) and (z7).

Vf(i=1)₂+Vf(i=2)_{A2}<Vf(i=3)_{A2}+Vf(i=4)_{A2}+Vf(i=5)_{A2}+Vf(i=6)_{A2}+Vf(i=7)_{A2} Formula (z2)

Vf(i=8)_{A2}+Vf(i=9)_{A2}<Vf(i=3)_{A2}+Vf(i=4)_{A2}+Vf(i=5)_{A2}+Vf(i=6)_{A2}+Vf(i=7)_{A2} Formula (z3)

5×(Vf(i=1)_{A2}+Vf(i=2)_{A2})<Vf(i=3)_{A}+Vf(i=4)_{A2}+Vf(i=5)_{A2}+Vf(i=6)_{A2}+Vf(i=7)_{A2} Formula (z4)

5×(Vf(i=8)_{A2}+Vf(i=9)_{A2})<Vf(i=3)_{A2}+Vf(i=4)_{A2}+Vf(i=5)_{A2}+Vf(i=6)_{A2}+Vf(i=7)_{A2} Formula (z5)

10×(Vf(i=1)_{A2}+Vf(i=2)_{A2})<Vf(i=3)_{A2}+Vf(i=4)_{A2}+Vf(i=5)_{A2}+Vf(i=6)_{A2}+Vf(i=7)_{A2} Formula (z6)

1×(Vf(i=8)_{A2}+Vf(i=9)_{A2})<Vf(i=3)_{A2}+Vf(i=4)_{A2}+Vf(i=5)_{A2}+Vf(i=6)_{A2}+Vf(i=7)_{A2} Formula (z7)

### [Preferred Distribution Shape of Bundle Width Zone: Effect]

The effect of satisfying the above formulas (x), (y) and (z) will be described below.

### (Effect 1)

When the above formulas (x), (y), and (z) are satisfied, it means that the number of reinforcing fiber bundles A2 in the zone (i=1) is less than that in the other zones (i=2 to 9). In other words, the fiber bundle distribution is missing in the (i=1) zone. Therefore, the drape property after preheating is stabilized when molding the composite material. Good drapability refers to a state in which both moderate flexibility and ease of carrying are achieved when the composite material is heated.

As the bundle width increases, the composite becomes softer and more flexible, but less portable. Conversely, as the bundle width decreases, the composite becomes stiffer and less flexible, but more portable.

In the case of the composite material satisfying the above formulas (x), (y) and (z), the number of fiber bundles present in the bundle width zone (i=1) is smaller than the others, and the fiber bundle widths are not widely distributed. Since a part of the fiber bundle is missing, it is easy to make the bundle width uniform. As a result, the width of the bundle becomes constant and the drape property is stabilized.

When the drape property is stabilized in this manner, the pre-shaping property of the composite material using a thermoplastic matrix resin is stabilized at the time of placing the composite material on the mold.

### (Effect 2)

It facilitates bundle distribution evaluation when manufacturing composite materials. When continuously producing composite materials, it is difficult to measure the bundle distribution of all composite materials. By measuring the bulk height of deposited reinforcing fibers, the bundle distribution can be easily predicted from the bulk height. The bulk height of a reinforcing fiber mat in which reinforcing fiber bundles that are a material for producing a composite material are deposited depends on the number of fiber bundles. In other words, in order to stabilize the bulk height of the reinforcing fiber mat, it is preferable to stabilize the number of fiber bundles.

If the above formulas (x), (y), and (z) are satisfied, and the number of reinforcing fiber bundles A2 in the zone of (i=1) is smaller than that of the other zones (i=2 to 9), the bundle width distribution becomes narrow, and the number of fiber bundles can be stabilized.

When the bulk height is measured during continuous production, and if the bulk height changes over time, it means that unevenness in the bundle distribution has occurred. Thus, the unevenness in the bundle distribution can be easily evaluated by just measuring the bulk height without measuring the bundle distribution one by one. Focusing on this point, the present invention can also be said to be a method for producing a reinforcing fiber deposit, which is a raw material for the following composite material.

### (Preferred Method for Producing a Reinforcing Fiber Deposit)

A method for producing a reinforcing fiber deposit that satisfies the following formulas (x), (y) and (z), in which the reinforcing fiber bundle A2 is divided into bundle width zones (i=1 to 9), and the volume fraction of the reinforcing fiber bundle A2 in each bundle width zone is Vfi_{A2}.

0≤Vf(i=1)_{A2}<10% Formula (x)

0<Vfi_{A2} is satisfied in two or more bundle width zones of i=2 to 9 Formula (y)

Vf(i=1)_{A2}<Vf(i=at least one of 2 to 9)_{A2} Formula (z)

### [Average Thickness T_{A2} of Reinforcing Fiber Bundle A2]

In the present invention, the average thickness T_{A2} of the reinforcing fiber bundles A2 is preferably less than 100 μm, more preferably less than 80 μm, still more preferably less than 70 μm, and even more preferably less than 60 μm. When the average thickness T_{A2} of the reinforcing fiber bundles A2 is less than 100 μm, the time required for impregnating the reinforcing fiber bundles with the matrix resin is shortened, and the impregnation proceeds efficiently.

The lower limit of the average thickness T_{A2} of the reinforcing fiber bundles A2 is preferably 20 μm or more. If the average thickness T_{A2} of the reinforcing fiber bundle A2 is 20 μm or more, the rigidity of the reinforcing fiber bundle A2 can be sufficiently secured.

The lower limit of the average thickness T_{A2} of the reinforcing fiber bundles A2 is more preferably 30 μm or more, still more preferably 40 μm or more.

### [Proportion of Reinforcing Fiber Bundle A2]

The fiber volume fraction (Vf_{A2(total)}) of the reinforcing fiber bundle A2 is preferably 10 Vol % or more and 90 Vol % or less, more preferably 15 Vol % or more to 70 Vol %, and still more preferably 15 Vol % or more to 50 Vol %, and particularly preferably 15 Vol % or more to 30 Vol %.

### [Reinforcing Fiber Bundle A3]

Reinforcing fiber bundles A3 having a bundle width of more than 3.0 mm may be included as reinforcing fibers A other than the reinforcing fiber bundles A2 and reinforcing fibers A1. The fiber volume fraction (Vf_{A3}) of the reinforcing fiber bundle A3 is preferably 15 Vol % or less. Although there is little problem even if the reinforcing fiber bundle A3 is mixed with the reinforcing fiber A at 10 vol % or less, it is more preferably 5 vol % or less, and even more preferably 3 vol % or less.

In addition, as described in WO2017/159264 pamphlet, if there is a joined bundle aggregate in which the reinforcing fiber bundles are not separated at all, resin pockets increase around the joined bundle aggregate, which becomes starting points of destruction of the composite material (molded article). In addition, if the non-impregnated portion protrudes on the surface, the appearance will be extremely deteriorated. Although impregnation is easy when a thermosetting matrix is used, this problem becomes significant when a thermoplastic matrix resin is used.

Furthermore, in the inventions described in WO2017/159264 pamphlet or WO2019/194090 pamphlet, a section in which separation treatment of fibers is not performed exists when the reinforcing fiber bundle is split, and the inventions include a huge fiber bundle called “a joined bundle aggregate” caused by the section in which separation treatment of fibers is not performed (non-separated fiber parts). For this reason, the joined bundle aggregate itself becomes the cause of defects. In addition, when a thermoplastic matrix is used, the reinforcing fibers and the thermoplastic matrix resin move excessively in the in-plane direction within the composite material in the impregnation process, resulting in unevenness of the reinforcing fiber volume fraction and fiber orientation of the composite material.

### [Measurement of Fiber Bundle]

As will be described later, the “fiber bundle” is recognized as a reinforcing fiber bundle that can be taken out with tweezers. In addition, regardless of the position that the tweezers pinch, the bundle of fibers that stick together as a bundle can be taken out as a bundle when the fibers are taken out. Therefore, the fiber bundle can be clearly defined. It is possible to confirm where plural fibers are grouped together and how the fibers are deposited in the aggregate of the reinforcing fibers by observing the aggregate of reinforcing fibers not only from the direction of its longitudinal side of fiber samples, but also from various directions and angles to collect the fiber samples for analysis, and it is possible to objectively and uniquely determine which fiber bundle functions as a group. For example, when fibers are overlapped, it can be determined that they are two fiber bundles if the fibers facing different directions at the crossing portion are not entangled with each other.

The width and thickness of each reinforcing fiber bundle are determined by considering three straight lines (x-axis, y-axis, and z-axis) that are orthogonal to each other. The longitudinal direction of each reinforcing fiber bundle is set as the x-axis. The longer one of the maximum value yₘₐₓ of the length in the y-axis direction and the maximum value zₘₐₓ of the length in the z-axis direction perpendicular thereto is taken as the width, and the shorter one is taken as the thickness. If yₘₐₓ is equal to zₘₐₓ, yₘₐₓ can be set as the width and zₘₐₓ can be set as the thickness.

Then, the average of the widths of the individual reinforcing fiber bundles obtained by the above method is set as the average bundle width of the reinforcing fiber bundles.

### [Reinforcing Fiber B]

The composite material in the present invention may contain reinforcing fibers B having a fiber length of less than 5 mm. The reinforcing fiber B may be a carbon fiber bundle, or may be in the form of a monofilament.

### [Weight Average Fiber Length of Reinforcing Fiber B]

The weight-average fiber length L_{B} of the reinforcing fibers B is not particularly limited, but the lower limit of L_{B} is preferably 0.05 mm or longer, more preferably 0.1 mm or longer, and even more preferably 0.2 mm or longer. When the weight average fiber length L_{B} of the reinforcing fibers B is 0.05 mm or more, the mechanical strength is easily ensured.

The upper limit of the weight-average fiber length L_{B} of the reinforcing fibers B is preferably less than the thickness of the molded article after molding the composite material. Specifically, the upper limit of L_{B} is preferably less than 5 mm, still more preferably less than 3 mm, and even more preferably less than 2 mm. The weight-average fiber length L_{B} of the reinforcing fibers B is determined by the formulas (1) and (2) as described above.

### [Resin]

The matrix resin used in the present invention may be thermosetting or thermoplastic. The matrix resin is preferably a thermoplastic matrix resin.

In this specification, the thermoplastic matrix resin (or thermosetting matrix resin) means the thermoplastic resin (or thermosetting resin) contained in the composite material.

On the other hand, the thermoplastic resin (or thermosetting resin) means a general thermoplastic resin (or thermosetting resin) before being impregnated into reinforcing fibers.

### 1. Thermoplastic Matrix Resin

When the resin is a thermoplastic matrix resin, the type thereof is not particularly limited, and one having a desired softening point or melting point can be appropriately selected and used. As the thermoplastic matrix resin, one having a softening point in the range of 180° C. to 350° C. is usually used, but the thermoplastic matrix resin is not limited thereto.

### 2. Thermosetting Matrix Resin

When the resin is a thermosetting matrix resin, the composite material is preferably a sheet molding compound (sometimes called as SMC) using reinforcing fibers. Due to its high shapeability, the sheet molding compound can be easily molded even into complex shapes. The sheet molding compounds have higher fluidity and shapeability than continuous fibers, and can easily form ribs and bosses.

### [Other Agents]

The composite material used in the present invention may contain: various fibrous fillers of organic fibers or inorganic fibers or non-fibrous fillers; and additives such as flame retardants, UV-resistant agents, stabilizers, release agents, pigments, softeners, plasticizers and surfactants.

### [Manufacturing Method of Composite Material (Example 1)]

The composite material in the present invention is preferably made into a sheet from a composite composition containing a resin and reinforcing fibers.

The “sheet” form refers to a planar shape whose length is 10 times or more as long as its thickness, in which the thickness is the smallest dimension and the length is the largest dimension among three dimensions that indicate the sizes of a composite material (for example, length, width, and thickness).

In the present invention, the composite composition refers to a state before reinforcing fibers are impregnated with a resin. A sizing agent (or binder) may be applied to the carbon fibers in the composite composition. The sizing agent or binder is not the matrix resin and may be applied in advance to the reinforcing fibers in the composite composition.

Various methods can be used for producing the composite composition depending on the forms of the resin and the reinforcing fibers. In addition, the method for producing the composite composition is not limited to the method described below.

### [Method for Producing Composite Material]

### Example 1: Use of Fixing Agent for Reinforcing Fiber Bundles

When producing a composite material in the present invention, a reinforcing fiber bundle fixing agent (simply called a fixing agent) may be used to control the bundle width of reinforcing fibers (especially reinforcing fiber A) to the desired bundle width and to control the bundle width distribution.

### 1. Manufacturing Process

When using a fixing agent for reinforcing fiber bundles, composite materials can be created by:

Step 1. Widening the (continuous) reinforcing fiber bundle unwound from the creel;

Step 2. Applying a fixing agent to the widened reinforcing fiber bundle to obtain a fixed reinforcing fiber bundle;

Step 3. Separating the fixed reinforcing fiber bundles;

Step 4. Preferably, cutting the separated fixed reinforcing fiber bundles that are arranged without gaps into a fixed length; and

Step 5. Impregnating the separated fixed reinforcing fiber bundle with resin.

In this specification, fixed reinforcing fiber bundles are not referred to as composite materials. A composite material in this specification is a fixed reinforcing fiber bundle impregnated with a thermoplastic (or thermosetting) matrix resin separately from a fixing agent.

In addition, widening means widening the width of the reinforcing fiber bundle (reducing the thickness of the reinforcing fiber bundle).

### 2. Fixing Agent for Reinforcing Fiber Bundles

### 2.1 Types of Fixing Agents

The step of applying the fixing agent is not particularly limited as long as it is performed during the manufacturing process. Preferably the fixing agent is applied after the reinforcing fiber bundle is widened, and the application is more preferably coating.

The type of fixing agent is not particularly limited as long as it can fix the reinforcing fiber bundle, but it is preferably solid at room temperature, more preferably resin, and still more preferably thermoplastic resin. It is most preferable that the fixing agent is compatible with a thermoplastic matrix resin if the thermoplastic matrix resin is used. Only one type of fixing agent may be used, or two or more types may be used.

When a thermoplastic resin is used as the fixing agent, one having a desired softening point can be appropriately selected and used according to the environment in which the fixed reinforcing fiber bundle is produced. Although the range of the softening point is not limited, the lower limit of the softening point is preferably 60° C. or higher, more preferably 70° C. or higher, and still more preferably 80° C. or higher. By setting the softening point of the fixing agent to 60° C. or higher, the fixing agent is solid at room temperature and has excellent handleability even in a usage environment at high temperatures in summer, which is preferable. On the other hand, the upper limit is 250° C. or lower, more preferably 180° C. or lower, still more preferably 150° C. or lower, and even more preferably 125° C. or lower. By setting the softening point of the fixing agent to 250° C. or less, it can be sufficiently heated with a simple heating device, and it is easy to cool and solidify, so the time until the reinforcing fiber bundle is fixed is short, which is preferable.

### 2.2 Plasticizer Added to Fixing Agent

A plasticizer may be added to the fixing agent. By lowering the apparent Tg of the thermoplastic resin used for the fixing agent, it becomes easier to impregnate the reinforcing fiber bundle.

### 2.3 Coating Method of Fixing Agent

### 2.3.1 Stepwise Coating

In the step of applying the fixing agent described above, the fixing agent may be applied in one step, or the fixing agent may be applied in two steps from the upper surface and the lower surface of the reinforcing fiber. In the case of two-step coating, it is preferable that the first step is melt coating (hot-melt coating) and the second step is coating a fixing agent dispersed in a solvent. From the viewpoint of simplifying the process of producing a composite material, it is more preferable to apply a fixing agent having a high permeability to the reinforcing fiber bundle in one step.

2.3.2 Comparison with Electrostatic Coating

When using a fixing agent, electrostatic coating may be used. However, when electrostatic coating is used, it is necessary to use a powder fixing agent, and depending on the usage conditions such as the particle shape, static electricity accumulates and there is a possibility of dust explosion. Solution coating or melt coating is preferred from the viewpoint of ensuring safety.

### 2.3.3 Coating by Spray Method

When applying the fixing agent to the reinforcing fiber bundle, the fixing agent may be dispersed in a solvent and discharged from a spray gun to adhere to the reinforcing fiber bundle. When the fixing agent dispersed in the solvent is discharged from the spray gun, it is preferable to spray it wider than the fiber bundle width in the range of 1 mm or more and 2 mm or less in addition to the widening width of the reinforcing fiber bundle to be sprayed. The concentration of the fixing agent dispersed in the solvent at the time of adhesion is preferably 5 wt % or less, more preferably 3 wt % or less, relative to the solvent. In addition, the discharge pressure of the spray used at that time is preferably 1 MPa or less, more preferably 0.5 MPa or less, still more preferably 0.3 MPa or less, in consideration of the degree of scattering of the fixing agent.

### 3. Fiber Separation Device

Although there is no particular limitation on the fiber separating device that separates the fixed reinforcing fiber bundle, the following fiber separating device is used.

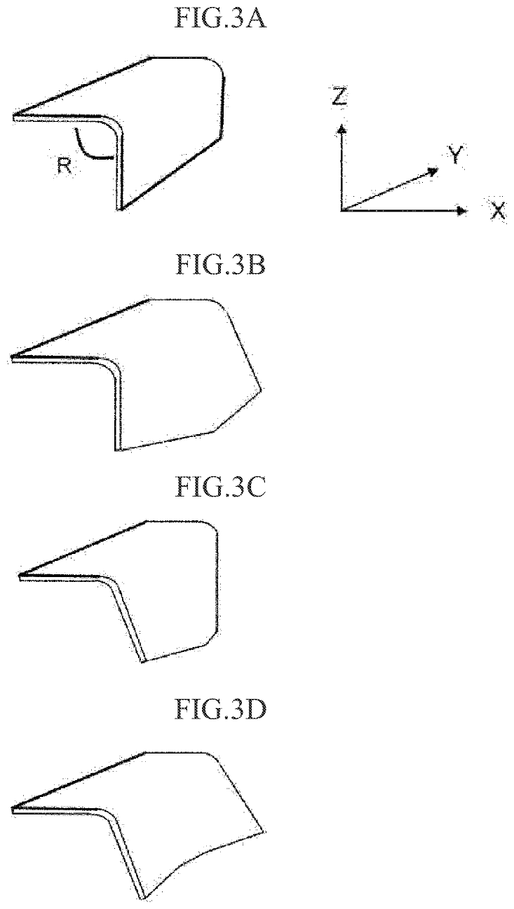

### 3.1 Pressing Against a Roller and Separating Fibers (FIG. 4)

FIG. 4 shows a schematic view of pressing a reinforcing fiber bundle (401) against a roller and separating the bundle with a blade (402). The bundle is pressed against a high-hardness support roller (403, rubber roller) that has undergone heat treatment such as quenching and separated. In this case, it is necessary to adjust so that the rubber roll is not damaged and the reinforcing fiber bundle is not caught.

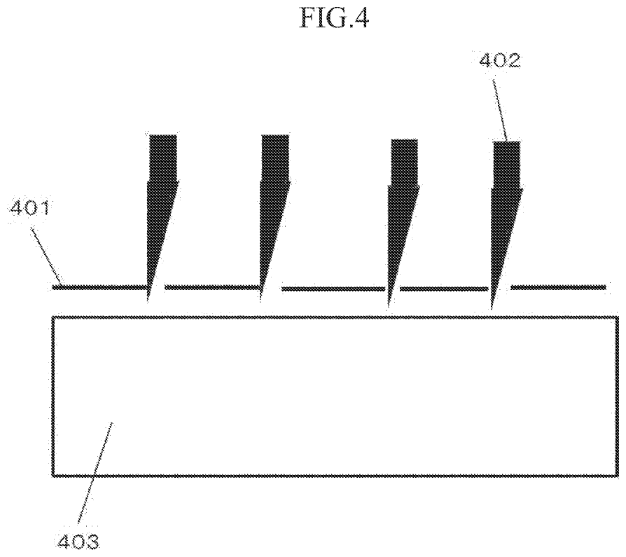

### 3.2 Share Blade Method (FIG. 5)

FIG. 5 shows a schematic diagram of separating the reinforcing fiber bundle by the shear blade method. In FIG. 5, an acute cutting edge (504) with a clearance angle is provided on the upper rotary blade (501), and is pressed against the side surface of the tip (505) of the lower rotary blade (502) for cutting. In this case, highly accurate clearance management is required constantly.

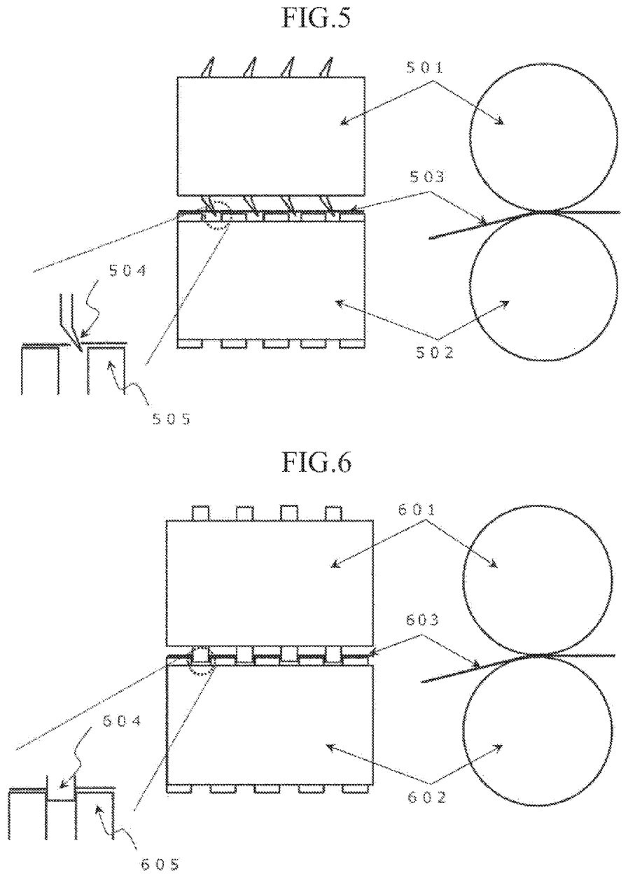

### 3.3 Gang Type Slit Method (FIG. 6)

FIG. 6 shows a schematic diagram of separating the reinforcing fiber bundle by the gang type slit method. In FIG. 6, an upper blade (604) provided on an upper rotary blade (601) which is a rotary round blade, and a lower blade (605) provided on a lower rotary blade are combined with each other in a configuration in which tips of the blades are overlapped with a small gap therebetween. The reinforcing fiber bundle is caught between the overlapping parts, and the bundle is separated by the shearing force of the overlapping parts of the upper and lower blades. As with the shear blade method, high-precision clearance management is required constantly.

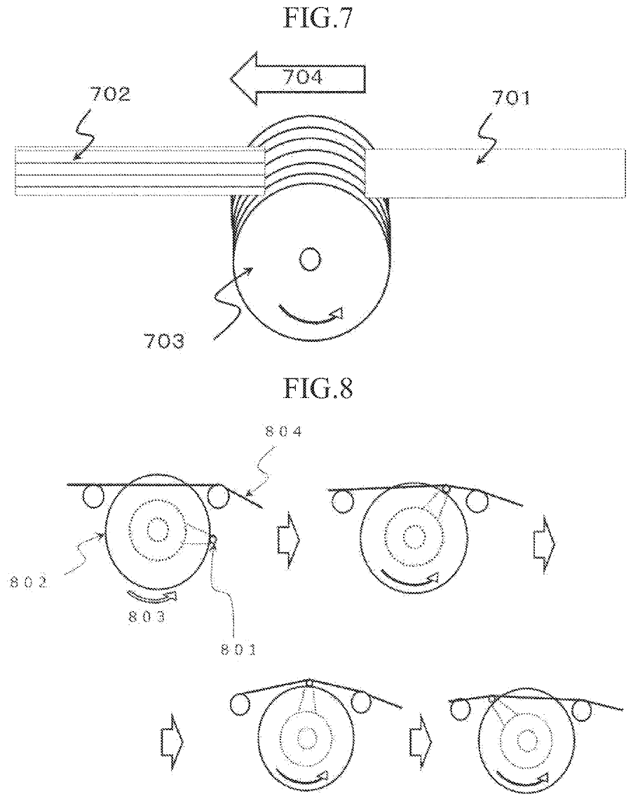

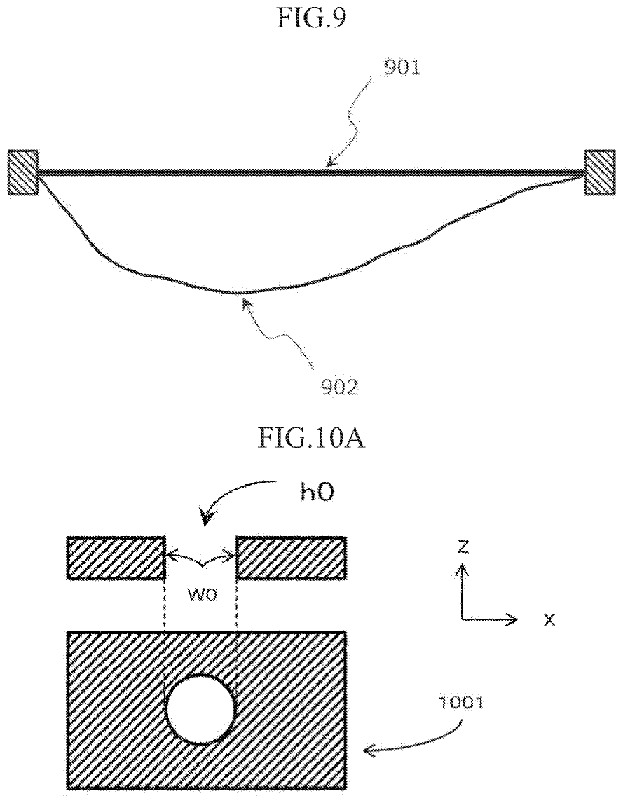

### 3.4 Insertion and Removal Method (FIG. 7 and FIG. 8)

FIG. 7 describes a fiber separation device. A reinforcing fiber bundle (701) is inserted into the fiber separating device (703) with a blade to obtain separated reinforcing fiber bundles (702). At this time, as shown in FIG. 8, it is preferable to make it difficult to rearrange the reinforcing fiber bundles in the blade by inserting and withdrawing the blade (801). In other words, if the reinforcing fiber bundle continues to pass through the blade, the slit will be misaligned, but by inserting and withdrawing the blade (801), the slit width can be easily corrected when the slit is misaligned.

It is preferable to keep the rotational speed of the blade (801) and the rotary blade (803) constant. On the other hand, the rotational speed of the blade (801) is preferably greater than 1.1 for the reinforcing fiber speed of 1.0. More specifically, when the peripheral speed of rotation of the blade (801) and the rotary blade (803) is V (m/min) and the conveying speed of the reinforcing fiber bundle is W (m/min), 1.0≤V/W is preferably satisfied, 1.0≤V/W≤1.5 is more preferably satisfied, 1.1≤V/W≤1.3 is still more preferably satisfied, and 1.1≤V/W≤1.2 is even more preferably satisfied.

In this regard, in the invention described in the pamphlet of WO2019/194090, 0.02≤V/W≤0.5 is satisfied, which results in the generation of undivided fiber bundles. The generation of such undivided fiber bundles causes defects in the molded article.

4. Fiber Bundle Distribution when Using Fixing Agent

FIGS. 1A to 1C show the fiber bundle distribution in a range of 0.3 mm to 3.0 mm in bundle width when an air flow is used such that the reinforcing fibers are not caught by a cutter or a roller when the reinforcing fiber bundle after widening and being fixed with a fixing agent is cut by a rotary cutter, and the caught reinforcing fibers are removed. FIGS. 1A, 1B and 1C show samples collected from locations at air volumes of 80 L/min, 120 L/min, and 160 L/min, respectively. Compared to FIGS. 2A to 2C, FIGS. 1A to 1C show that fixed reinforcing fiber bundles results in a uniform bundle distribution (in other words, a relatively small coefficient of variation in a particular bundle width zone).

### [Manufacturing Method of Composite Material (Example 2)]

A composite material may be obtained by impregnating a widened carbon fiber bundle with a thermoplastic matrix resin in advance and then cutting the carbon fiber bundle.

For example, plural carbon fiber strands are arranged in parallel, and a known widening device (e.g., widening using air flow, widening through multiple bars made of metal or ceramic, widening using ultrasonic waves, etc.) is used to make the strands have a desired thickness, the carbon fibers are aligned, and integrated with a desired amount of thermoplastic matrix resin, thereby an integrated object (hereinafter referred to as UD prepreg) is formed. After that, the UD prepreg is passed through a gang type slitter and slit.

At this time, the slitter is designed so that reinforcing fibers A1 having a fiber width of less than 0.3 mm and reinforcing fiber bundles A2 having a bundle width of 0.3 mm or more and 3.0 mm or less are included. Furthermore, the slitter is provided with slit areas so that the reinforcing fiber bundles A2 are present in each of plural bundle width zones (the total number n of bundle width zones satisfies n≥3).

After slitting, the fibers are cut to a certain length to create chopped strand prepregs. The obtained chopped strand prepregs are preferably deposited and laminated uniformly so that the fiber orientations become random. The composite material of the present invention is obtained by: heating and pressurizing the laminated chopped strand prepregs; melting the thermoplastic matrix resin existing in the chopped strand prepregs; and integrating the plural chopped strand prepregs. Moreover, the method of applying the thermoplastic resin is not particularly limited. For example, a method of directly impregnating the reinforcing fiber strands with a molten thermoplastic resin, a method of melting a film-like thermoplastic resin and impregnating the reinforcing fiber strands with the resin, a method of melting a powdery thermoplastic resin and impregnating the reinforcing fibers with the resin, and the like are present. The method for cutting reinforcing fibers impregnated with a thermoplastic resin is not particularly limited, but a pelletizer, or cutters of guillotine method or Kodak method may be used. As a method for randomly and uniformly depositing and laminating chopped strand prepregs, for example, a method of allowing the prepreg obtained by cutting to fall directly from a high position to deposit the prepreg on a belt conveyor such as a steel belt; a method of blowing air into the drop path of the prepreg; or a method of attaching a baffle plate in the drop path, can be considered in the case of continuous production. In the case of batch production, a method of: accumulating cut prepregs in a container; attaching a conveying device to the bottom surface of the container; and distributing the prepregs to a mold for sheet production is considered.

### [Other Facilities]

A widening monitoring device may be provided to provide feedback so that the reinforcing fibers can be widened to an appropriate width. A laser displacement meter or an X-ray can also be used to measure the basis weight of reinforcing fibers. A fluff suction device or the like may be used to remove fluff generated from the reinforcing fibers.

### [Relationship Between Composite Material and Molded Article]

In the present invention, a composite material is a material for forming a molded article, and the composite material is preferably press-molded (also called compression molding) to form a molded article. Therefore, the composite material in the present invention preferably has a flat plate shape, but the molded article is shaped into a three-dimensional shape.

When a thermoplastic matrix resin is used and the composite material is cold pressed, the morphology of the reinforcing fibers is almost maintained before and after molding. Therefore, the morphology of the reinforcing fibers of the composite material can be understood by analyzing the morphology of the reinforcing fibers contained in the molded article.

### [Molded Article]

The composite material in the present invention is preferably for press-molding to produce a molded article. When the resin is a thermoplastic matrix resin, the press molding is preferably cold press molding.

### [Press Molding]

Press molding is used as a preferable molding method for manufacturing a molded article using a composite material, and molding methods such as hot press molding and cold press molding can be used.

When the matrix resin is a thermoplastic matrix resin, press molding using a cold press is particularly preferred. In the cold press method, for example, a composite material heated to a first predetermined temperature is put into a mold set to a second predetermined temperature, and then pressurized and cooled.

Specifically, when the thermoplastic matrix resin forming the composite material is crystalline, the first predetermined temperature is equal to or higher than the melting point, and the second predetermined temperature is lower than the melting point. When the thermoplastic matrix resin is amorphous, the first predetermined temperature is equal to or higher than the glass transition temperature, and the second predetermined temperature is below the glass transition temperature. That is, the cold press method includes at least the following steps A2) to A1).

Step A2) A step of heating the composite material to a temperature equal to or higher than the melting point and equal to or lower than the decomposition temperature when the thermoplastic matrix resin is crystalline, or to a temperature equal to or higher than the glass transition temperature and equal to or lower than the decomposition temperature when the thermoplastic matrix resin is amorphous.

Step A1) A step of placing the composite material heated in the above step A2) in a mold whose temperature is adjusted to below the melting point when the thermoplastic matrix resin is crystalline or below the glass transition temperature when the thermoplastic matrix resin is amorphous; and pressurizing the composite material.

By performing these steps, the molding of the composite material can be completed.

Each of the above steps must be performed in the above order, but other steps may be included between each step. The other steps may be, for example, a shaping step in which, prior to step A1), pre-shaping the composite material into the shape of the cavity of the mold using a shaping mold different from the mold used in step A1). The step A1) is a step of applying pressure to the composite material to obtain a molded article having a desired shape. The molding pressure at that time is not particularly limited, but it is preferably less than 20 MPa, and more preferably 10 MPa or less.

In addition, as a matter of course, various steps may be interposed between the above steps during press molding. For example, vacuum press molding may be used in which press molding is performed while vacuuming.

### [Springback]

### 1. Description of Springback

When the matrix resin is a thermoplastic matrix resin, it is necessary to preheat or heat the composite material to a predetermined temperature to soften or melt the composite material in order to perform cold press molding using the composite material. The composite material containing reinforcing fibers that are discontinuous fibers having a fiber length of 5 mm or more, especially in the form of a mat of deposited reinforcing fibers, expands due to springback of the reinforcing fibers and the bulk density changes when the thermoplastic matrix resin becomes plastic during preheating. When the bulk density changes during preheating, the composite material becomes porous, the surface area increases, air flows into the composite material, and the thermal decomposition of the thermoplastic matrix resin is promoted. Here, the springback amount is a value obtained by dividing the thickness of the composite material after preheating by the thickness of the composite material before preheating.

When the ratio of the reinforcing fibers A1 to the reinforcing fibers A increases or the fiber length increases, the springback amount tends to increase.

### 2. Springback Control

The matrix resin is preferably a thermoplastic matrix resin, and the springback amount, which is the ratio of the thickness after preheating to the thickness before preheating, of the composite material is preferably more than 1.0, and its coefficient of variation CVs is preferably less than 35%.

Here, the coefficient of variation CVs is calculated by the formula (c).

Coefficient of variation CVs=100×standard deviation of springback amount/average of springback amount formula (c)

Here, it is preferable to divide the composite material at a pitch of 100 mm×100 mm, measure each CVs, and obtain the coefficient of variation CVs. It is defined by the coefficient of variation measured by dividing into 10 places).

When measuring a composite material, it is preferable to measure at a pitch of 100 mm×100 mm, but the size of the composite material or molded article may be small, and only one sample may be collected from one composite material or molded article even sampling is attempted at a pitch of 100 mm×100 mm. In this case, 10 composite materials or molded articles may be prepared, one sample may be taken from each of these 10 molded articles, and the coefficient of variation of 10 samples (10 pieces) may be calculated. Further, in the case where a composite material or a molded article has a planar body having a dimension of 1000 mm×100 mm, CVs is obtained by dividing the planar body into 10 samples and defined by coefficient of variations of values measured at 10 locations.

If the coefficient of variation CVs is less than 35%, the production stability is improved when the composite material is cold-pressed to produce a molded article. In particular, it is advantageous when forming a deep drawn shape, a hat shape, a corrugated shape, a cylindrical shape, or the like.

### 3. Preferred Springback Amount

The springback amount is preferably more than 1.0 and less than 14.0, more preferably more than 1.0 and less than 7.0, still more preferably more than 1.0 and less than 5.0, and still further preferably more than 1.0 and 3.0 or less.

### [Superiority During Molding]

By using the present invention, the springback is stabilized not only when one sheet of composite material is observed, but also when a large number of composite materials are compared and observed. Therefore, when a robot hand is used for molding, the robot hand can stably grip the composite material when pre-shaping and arranging the composite material in a mold having a complicated shape, and it is easy to release the grip.

### [Improved Hole-In-Mold Stability]

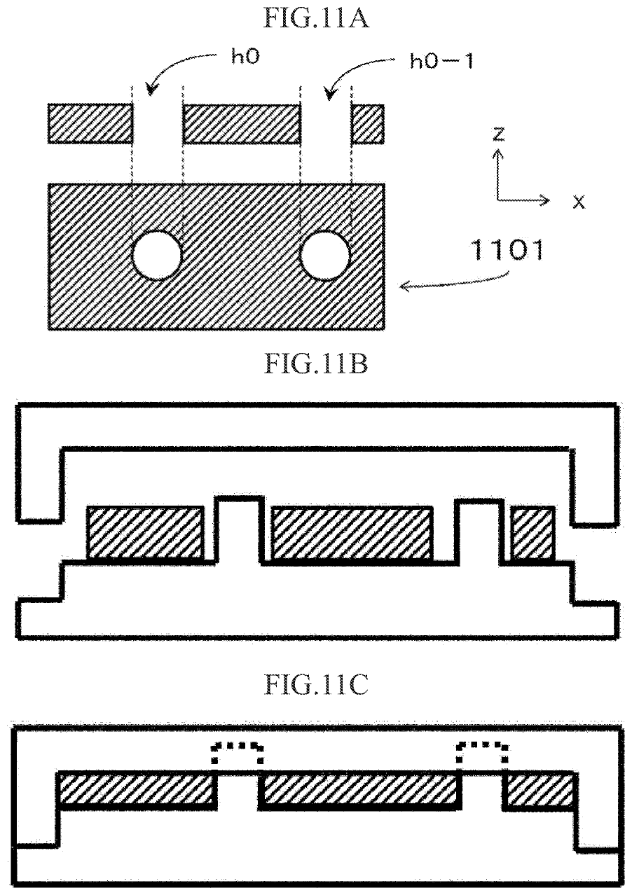

When a molded article provided with a hole hl is produced by cold pressing, a hole-forming member for forming the hole hl in the molded article is provided in at least one of a pair of male and female molds, and after forming a hole h0 on a composite material having a thickness t, the composite material is placed in a mold such that the hole h0 corresponds to the hole-forming member and the composite material is pressed (eg, FIGS. 10A to 10C).

The hole forming member for forming the hole hi at the desired position of the molded article may be provided in at least one of the pair of male and female molds (that is, the upper mold or the lower mold). For example, a projection (1002) of the lower mold as shown in FIG. 10B can be exemplified. The hole forming member is provided by arranging a pin in the mold, and is sometimes called a core pin. FIGS. 10A to 10C show an example of a mold for producing a molded article in a cross-sectional schematic view. The molds include a male and female pair of upper and lower molds (1003, 1004) attached to a press device (not shown). Normally, one of them, and sometimes both of them, are movable in the opening/closing direction of the mold (in the figure, the male mold is fixed and the female mold is movable).

These molds have a cavity surface corresponding to the shape of the product. In FIGS. 10A to 10C, a hole forming member for forming an opening at a predetermined position can move forward and backward within the mold in the opening and closing direction of the mold. The hole forming member having the same cross-sectional shape as the hole h1 of the target molded article is provided corresponding to the position of the hole hl of the target molded article. The hole-forming member may be provided in either male or female mold, but the hole-forming member may be provided in one mold for placing the composite material. In some cases, the hole-forming members may be provided in both of the male and female molds so that the leading end surfaces of the hole forming members come into contact with each other when the molds are clamped.

A method for manufacturing a molded article using the mold shown in FIGS. 10A to 10C will be described below. The male and female molds (1003, 1004) are opened and the composite material (1001) is placed on the cavity surface of the male mold (1003). A hole h0 having a projected area larger than that of the hole forming member (1002) is formed in the composite material at a position corresponding to the hole forming member (1002) provided in the mold (FIG. 10B). The composite material (1001) is placed on the lower mold by inserting the hole forming member (1002) into the hole h0 (FIG. 3B).

Placing the composite material having a hole h0 corresponding to the hole-forming member in the mold specifically means placing the hole-forming member through the hole h0 of the composite material.

After placing the composite material with the hole forming member 1002 inserted into the hole h0 on the cavity surface of the lower mold 1003, the upper mold 1004 starts to descend. As the upper mold descends, the tip surface of the hole forming member provided on the lower mold and the forming surface of the upper mold come into contact with each other. As the upper mold continues to descend, the hole-forming member is accommodated in a housing portion (not shown) for the hole-forming member previously provided in the upper mold (1004 in FIG. 10B). The composite material (1001) flows to produce a molded article having a hole hl.

After completion of molding, the male and female molds are opened and the molded article is taken out to obtain a molded article having a hole hl.

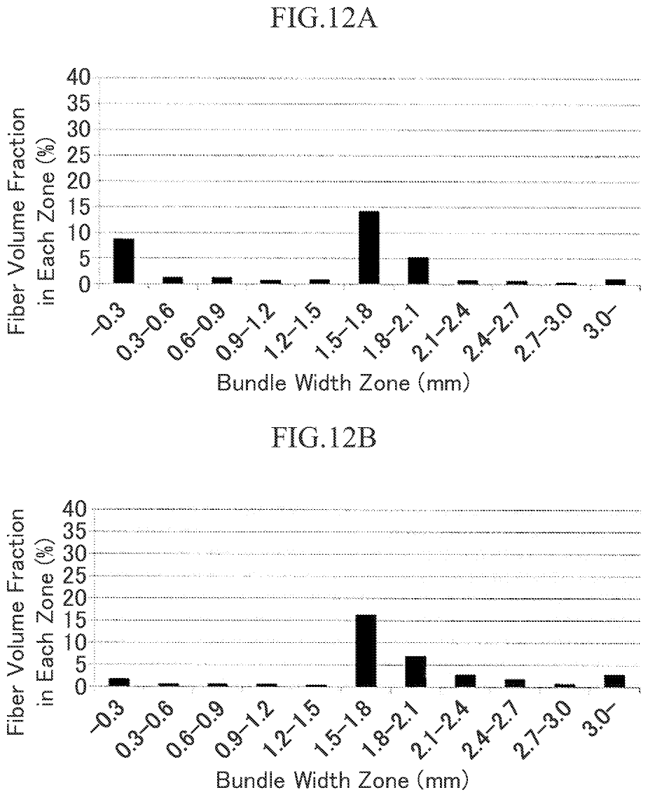

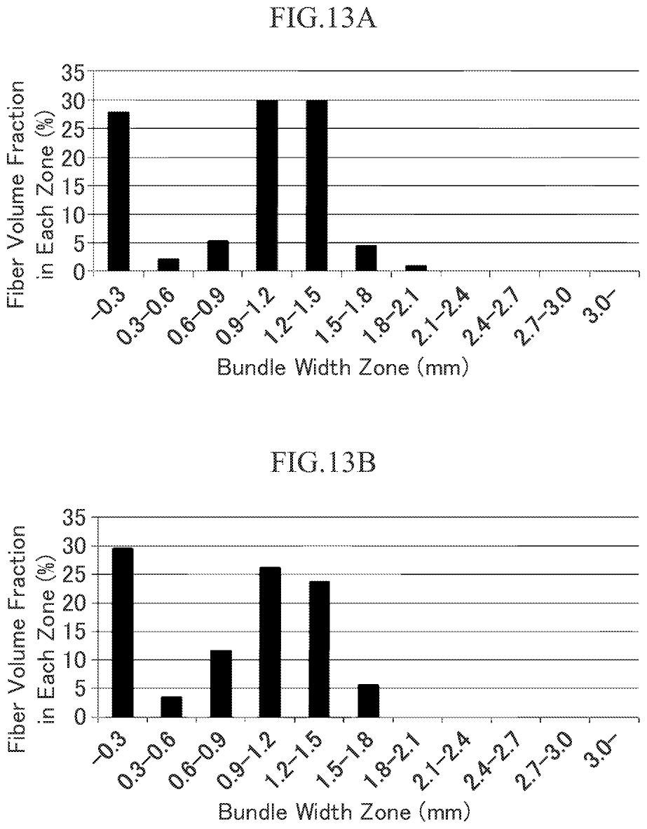

FIGS. 11A to 11C illustrate the production of a molded article with two holes.

When forming holes in molds using a robot hand, the coordinates of the hole h0 made in the composite material and the coordinates of the end of the composite material are used as references so that the robot hand can grasp the same position each time.

At this time, if there is little variation in the degree of springback of the composite material, misalignment of the reference coordinates (for example, the hole h0) is less likely to occur. As a result, the composite material can be accurately gripped by the robot hand, and the position at which the composite material is placed in the mold can be stabilized.

[Measurement with 100 mm×100 mm Pitch of Composite Material]

When measuring the composite material of the present invention, it is preferable to measure at a pitch of 100 mm×100 mm, but the size of the composite material or molded article may be small, and only one sample may be collected from one composite material or molded article even sampling is attempted at a pitch of 100 mm×100 mm. In this case, 10 molded articles may be prepared, one sample may be taken from each of these 10 molded articles, and the coefficient of variation of 10 samples (10 pieces) may be calculated.

### EXAMPLES

The present invention will be specifically described below using Examples, but the present invention is not limited thereto.

### 1. Raw Materials Used in the Following Examples are as Follows.

### 1.1 PAN-Based Carbon Fiber

(1) Carbon fiber “Tenax” (registered trademark) STS40-48K manufactured by Teijin Limited (average fiber diameter 7 μm, fineness 3200 tex, density 1.77 g/cm³)

(2) Carbon fiber “Tenax” (registered trademark) STS40-24K (EP) manufactured by Teijin Limited (average fiber diameter 7 μm, fineness 1600 tex, density 1.78 g/cm³)

### 1.2 Resin

Polyamide 6 (A1030 manufactured by Unitika Ltd., sometimes abbreviated as PA6). After impregnating the reinforcing fibers, it becomes a thermoplastic matrix resin.

Polyamide 6 film (manufactured by Unitika Ltd., “Emblem ON-25”, melting point 220° C.)

### 1.3 Fixing Agent

Fixing agent 1: resin composition of PA6 and plasticizer

was prepared by mixing 100 parts by mass of polyamide 6 (A1030 manufactured by Unitika Ltd.) with 50 parts by mass of p-hydroxybenzoic acid 2-hexyldecyl ester (Exepar HD-PB manufactured by Kao Corporation).

Fixing agent 2: Copolyamide

A two-fold dilution of Griltex 2A (resin 40%, water 60%) microsuspension manufactured by Ems-Chemie Japan Ltd. was prepared by diluting the microsuspension twice with water. The resin component (solid content) of the diluted fixing agent 2 is 20%.

Melting range 120-130° C.

Fixing agent 3: Copolymerized nylon “VESTAMELT” (registered trademark) Hylink manufactured by Daicel-Evonik Corporation, thermoplastic resin, melting point 126° C.

Fixing agent 4:

A four-fold dilution of Griltex 2A (40% resin, 60% water) microsuspension manufactured by Ems-Chemie Japan Ltd. was prepared by diluting the microsuspension 4 times with water. The resin component (solid content) of the diluted fixing agent 4 is 10%.

2. Each Value in this Example was Determined According to the Following Method.

### (1) Measurement of Reinforcing Fiber

### (1.1) Sample Creation

Ten samples of 100 mm×100 mm are cut out from the composite material, and the samples are heated in an electric furnace (FP410 manufactured by Yamato Scientific Co., Ltd.) heated to 500° C. in a nitrogen atmosphere for 1 hour to burn off organic substances such as matrix resin.

### (1.2) Reinforcing Fiber Volume Fraction (Vfₜₒₜₐₗ) Contained in Composite Material

The weight of the reinforcing fiber and the weight of the thermoplastic matrix resin were calculated by weighing the weight of the sample before and after burning off. Next, using the specific gravity of each component, the volume fraction of the reinforcing fiber and the thermoplastic matrix resin were calculated for each of the 10 samples.

Reinforcing fiber volume fraction (Vfₜₒₜₐₗ)=100×reinforcing fiber volume/(reinforcing fiber volume+thermoplastic matrix resin volume) formula (3)

### (1.3) Measured Number of Fiber Bundles

0.5 g of reinforcing fibers contained in one 100 mm×100 mm sample (after burning off) was sampled, and a total of 1200 reinforcing fibers A having a fiber length of 5 mm or more were randomly extracted with tweezers.

The measured number of reinforcing fibers is obtained from the n value derived from the following formula (4) with a tolerance ε of 3%, a reliability μ(a) of 95%, and a population ratio of ρ=0.5 (50%).

n=N/[(ε/μ(α))²×{(N−1)/ρ(1−ρ)}+1] formula (4)

n: Required number of samples

μ(α): 1.96 at 95% reliability

N: population size

ε: tolerance

ρ: population ratio

Here, in the case of a sample obtained by cutting a 100 mm×100 mm×2 mm thick composite material of reinforcing fiber volume (Vfₜₒₜₐₗ)=35% and burning it off, the size N of the population is obtained by:

(100 mm×100 mm×2 mm thick×Vfₜₒₜₐₗ35%)÷((Diμm/2)²×π×fiber length×number of monofilaments contained in the fiber bundle).

If the fiber diameter Di is 7 μm, the fiber length is 20 mm, and the number of monofilaments included in the fiber bundle is designed to be 1000, then N≈9100.

Substituting this value of N into the above formula (4), the required number of samples n is about 960. In this example, in order to improve the reliability, 1200 fibers, which is a little more than the above, were extracted from a sheet of 100 mm×100 mm sample and measured.

### (2) Measurement of Fiber Volume Fraction

### (2.1) Reinforcing Fiber A1, Reinforcing Fiber Bundle A2, Reinforcing Fiber Bundle A3

The reinforcing fibers A (1200 pieces) taken out in (1.3) were divided into: reinforcing fiber A1 (fiber width of less than 0.3 mm); reinforcing fiber bundle A2 (bundle width of 0.3 mm or more and 3.0 mm or less); and A3 (bundle width of more than 3.0 mm). The weights of the reinforcing fiber A1, the reinforcing fiber bundle A2, and the reinforcing fiber bundle A3 were measured using a balance capable of measuring up to 1/1000 mg. Based on the measured weights, the volume fractions of the reinforcing fiber A1, the reinforcing fiber bundle A2, and the reinforcing fiber bundle A3 were calculated using the density (ρ_{cf}) of the reinforcing fiber using the formulas (3-1), (3-2) and (3-3).

$$Formula ( 3 - 1 )$$

$$Reinforcing fiber volume fraction ( {Vf}_{A 1} ) = 100 \times volume of reinforcing fiber A 1 / ( volume of reinforcing fiber + volume of matrix resin ) = {Vf}_{total} \times ( ( weight of reinforcing fibers A 1 ) / {ρ}_{cf} ) / ( weight of all reinforcing fibers ) / {ρ}_{cf} )$$

$$Formula ( 3 - 2 )$$

$$Reinforcing fiber volume fraction ( {Vf}_{A 2 ( total )} ) = 100 \times volume of reinforcing fiber A 2 / ( volume of reinforcing fiber + volume of matrix resin ) = {Vf}_{total} \times ( ( weight of reinforcing fiber bundle A 1 ) / {ρ}_{cf} ) \text{} / ( weight of all reinforcing fibers ) / {ρ}_{cf} )$$

$$Formula ( 3 - 3 )$$

$$Reinforcing fiber volume fraction ( {Vf}_{A 3} ) = 100 \times volume of reinforcing fiber A 3 / ( volume of reinforcing fiber + volume of matrix resin ) = {Vf}_{total} \times ( ( weight of reinforcing fiber bundle A 3 ) / {ρ}_{cf} ) \text{} / ( weight of all reinforcing fibers ) / {ρ}_{cf} )$$

### (2.2) Fibers in Each Bundle Width Zone of Reinforcing Fiber Bundle A2

The reinforcing fiber bundle A2 was further divided into the following bundle width zones (i=1 to 9 zones), and the weight of each bundle width zone was measured using a balance capable of measuring up to 1/1000 mg.

| | |
|---|---|
| Bundle width zone (i = 1) | 0.3 mm ≤ bundle width < 0.6 mm |
| Bundle width zone (i = 2) | 0.6 mm ≤ bundle width < 0.9 mm |
| Bundle width zone (i = 3) | 0.9 mm ≤ bundle width < 1.2 mm |
| Bundle width zone (i = 4) | 1.2 mm ≤ bundle width < 1.5 mm |
| Bundle width zone (i = 5) | 1.5 mm ≤ bundle width < 1.8 mm |
| Bundle width zone (i = 6) | 1.8 mm ≤ bundle width < 2.1 mm |
| Bundle width zone (i = 7) | 2.1 mm ≤ bundle width < 2.4 mm |
| Bundle width zone (i = 8) | 2.4 mm ≤ bundle width < 2.7 mm |
| Bundle width zone (i = 9) | 2.7 mm ≤ bundle width ≤ 3.0 mm |

Based on the measured weight, the volume fraction (Vf(i=k)_{A2}) of the reinforcing fiber bundle A2 in the bundle width zone (i=k) is calculated using the density (ρcf) of the reinforcing fiber using the formula (3-5).

Vf(i=k)_{A2}=Reinforcing fiber volume fraction (Vfₜₒₜₐₗ)×(total weight of reinforcing fiber bundle A2 in bundle width zone (i=k)/ρ_{cf})×100/(weight of all reinforcing fibers/ρ_{cf}) Formula (3-5):

(3) Coefficient of Variation CV_{A1}, Coefficient of Variation CVi_{A2}, Coefficient of Variation CV_{A3}

The operations in (2) were repeated with the 10 samples obtained in (1.1), and the volume fraction Vf_{A1} of the reinforcing fiber A1, the volume fraction Vfi_{A2} of the reinforcing fiber bundle A2 in each bundle width zone, and the volume fraction Vf_{A3} of the reinforcing fiber bundle A3 were determined. After that, the coefficient of variation CV_{A1}, the coefficient of variation CVi_{A2}, and the coefficient of variation CV_{A3} were calculated from the average and standard deviation among the 10 samples.

### (4) Fiber Length

### (4.1) Use of Scanned Images

0.5 g was collected from the reinforcing fibers A (1200 pieces) taken out in (1.3), and divided into reinforcing fibers A1, reinforcing fiber bundles A2, and reinforcing fiber bundles A3. The fiber length of the reinforcing fibers A1 was also measured.

The reinforcing fiber bundle A2 and the reinforcing fiber bundle A3 were arranged on a transparent A4 size film so that the fiber bundles A2 and A3 did not overlap, and were covered with a transparent film and laminated to fix the fiber bundles.

The fiber bundles laminated with the transparent film was scanned in full color, JPEG format, 300×300 dpi, and saved in a personal computer. This operation was repeated to obtain scanned images of the reinforcing fiber bundles A2 and A3 included in the reinforcing fibers A (1200 pieces). The fiber length and fiber bundle width were measured from the obtained scanned image using an image analyzer Luzex AP manufactured by Nireco Corporation. By measuring with this method, errors between measurers were eliminated.

### (4.2) Weight Average Fiber Length of Reinforcing Fiber a Contained in Composite Material

The weight average fiber length L was calculated from the measured fiber length of the reinforcing fiber A by the following formula.

Weight average fiber length L=(ΣLi²)/(ΣLi) Formula (2)

### (5) Drapability Evaluation

A 100 mm×100 mm sample was cut out from the composite material, and placed in an IR oven such that only the sample area of 100 mm×50 mm was placed on a separately prepared 200 mm×200 mm wire mesh. Then the sample was heated to a temperature of melting point plus 60° C. of the thermoplastic matrix resin of the composite material. After heating, the sample and the wire mesh were slowly removed from the oven, and the wire mesh was placed on the edge of the surface plate so that the sample part not on the wire mesh protruded from the surface plate and the protruding part of the heated composite material sample hung down under its own weight. In addition, a weight was placed on the composite material sample on the wire mesh side to fix the sample so that the sample would not fall off the surface plate. After that, the composite material sample was cooled to a temperature at which the sample solidified, and the sample was removed from the wire mesh. The angle (R, see FIG. 3A) of the portion bent under its own weight was measured with a protractor using the surface where the sample was placed on the wire mesh as a reference surface.

Measurements were performed at 5 points in the Y-axis direction in FIG. 3A at a pitch of 25 mm from the end of the composite material sample after heating, and the coefficient of variation was calculated by the formula (d).

Coefficient of variation Ra=100×standard deviation of R/average of R formula (d)

Perfect: Coefficient of variation Ra is 3% or less

Excellent: The coefficient of variation Ra is more than 3% and 5% or less

Good: The coefficient of variation Ra is more than 5% and 10% or less

Bad: Coefficient of variation Ra exceeds 10%

### (6) Evaluation of Impregnation Unevenness (Measurement of Tensile Strength)

A dumbbell test piece was cut out from a molded article (width 200 mm×250 mm) to be described later using a water jet. The test pieces were cut out from a total of 10 sheets cut out every 20 m, which will be described later. With reference to JIS K 7164 (2005), a tensile test was performed using an Instron 5982R4407 universal testing machine manufactured by Instron Co. Ltd. The shape of the test piece was A-type test piece. The chuck-to-chuck distance was 115 mm, and the test speed was 5 mm/min. An average was calculated from each measured value and a coefficient of variation were calculated using the following formula.

Coefficient of variation of tensile strength=100×standard deviation of tensile strength/average of tensile strength formula (5)

### (7) Transferability of Heated Composite Material

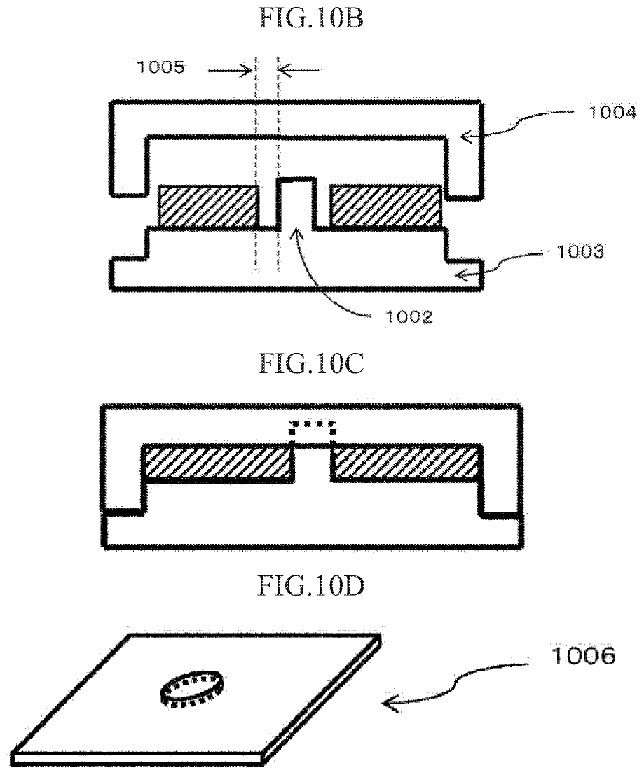

A 100 mm×1500 mm sample was cut from the composite material. At this time, 1500 mm in the longitudinal direction of the sample is taken as the original composite material length L (before). The sample was heated in an IR oven to the melting point plus 60° C. of the thermoplastic matrix resin contained in the composite material (280° C. when the thermoplastic matrix resin is PA6). After heating, the composite material was gripped at positions 25 mm from both ends in the longitudinal direction of the composite material so that the heated composite material sagged under its own weight. Sign 902 in FIG. 9 indicates the composite material that has been heated and sagged under its own weight. Then, after waiting for the composite material to cool and solidify, the longitudinal distance L (after) of the composite material after cooling was measured, and the elongation ratio of the composite material before and after heating was calculated.

Elongation ratio=100×L (after)/L (before)

Excellent: The elongation rate is 100% or more and less than 110%

Good: elongation rate is 110% or more and 200% or less

Bad: The composite material is broken and cannot be measured.

### (8) Evaluation of Bulk Height Measurement

The fixed carbon fiber bundle was slit and separated using the slitting device shown in FIG. 4, and then cut to a fixed length of 20 mm using a rotary cutter. and placed directly below the rotary cutter. The cut fiber bundles were dispersed and fixed on a thermoplastic resin aggregate prepared in advance on an air-permeable support that continuously moved in one direction and that had a suction mechanism at the bottom. Thereby a carbon fiber aggregate with width 200 mm×length 10 m was obtained. The thickness of the applied carbon fiber aggregate was measured 10 times every 1 m (total length is 10 m) in the MD direction (Machine Direction) with a laser thickness gauge (in-line profile measuring device LJ-X8900 manufactured by Keyence), thereby a change in thickness was investigated over time.

Next, 10 g of the carbon fiber aggregate was sampled at each location where the thickness was measured. The sampled carbon fiber aggregate is heated for 1 hour in an electric furnace (FP410 manufactured by Yamato Scientific Co., Ltd.) heated to 500° C. in a nitrogen atmosphere to burn off organic substances such as a matrix resin. The volume fraction of the carbon fibers A1 to the total carbon fibers was measured for the burnt-off samples.

Coefficient of determination R² was calculated when the obtained bulk height value was taken as the x-axis of the scatter diagram and the volume fraction of the obtained carbon fibers A1 was taken as the y-axis of the scatter diagram. The coefficient of determination is an index that indicates how well the predicted value of the objective variable obtained by regression analysis matches the actual value of the objective variable.

Excellent: R²=0.9 or more

Good: R²=0.6 or more and less than 0.9

Bad: R²=less than 0.6

### Example 1

A thermoplastic resin assembly was prepared using a feeder and nylon 6 resin A1030 (sometimes called PA6) manufactured by Unitika Co., Ltd. as a thermoplastic resin by spraying and fixing the thermoplastic resin onto an air-permeable support that continuously moved in one direction and was installed under the feeder.

Carbon fiber “Tenax” (registered trademark) STS40-48K manufactured by Teijin Limited was used as the reinforcing fiber, and the carbon fiber bundle was widened to a width of 40 mm by an air flow so that the thickness of the carbon fiber bundle was 100 sm.

Then, fixing agent 1 was melt-adhered to the carbon fiber from the upper surface using a hot applicator (Suntool Co., Ltd.) so as to be 3 wt % with respect to the carbon fiber.

After cooling this to room temperature, the fixing agent 2 is coated on an undersurface of the carbon fiber using a kiss touch roll (rotation speed: 5 rpm) so that the solid content of the fixing agent 2 is 0.5 wt % with respect to the carbon fiber. Observation of the carbon fiber bundle after drying revealed that a fixed carbon fiber bundle was obtained in which the widened state was fixed and maintained.

This fixed carbon fiber bundle was separated by slitting using a slitting device shown in FIG. 4 (separating by pressing against a rubber roll). After that, the bundles were cut to a fixed length of 20 mm using a rotary cutter. The cut fiber bundles were dispersed and fixed on a thermoplastic resin aggregate prepared in advance on an air-permeable support that was installed directly below the rotary cutter and that had a suction mechanism at the bottom and continuously moved in one direction, to obtain a carbon fiber aggregate. The supply amount of carbon fibers was set so that the volume fraction of carbon fibers to the composite material was 35% and the average thickness of the composite material was 2.0 mm.

When the rotary cutter was used to cut the carbon fiber to a fixed length of 20 mm, the carbon fiber was detached from the roll by the negative pressure generated in the air stream. The composite composition was produced with a width of 200 mm and a length of 1000 m (composite material production speed of 2 m/min), and the air flow at this time was not constant and was turbulent over time.

A composite composition including the carbon fiber aggregate and the thermoplastic resin aggregate was heated in a continuous impregnation device to impregnate the carbon fibers with the thermoplastic resin and then cooled.

A total of 10 sheets of composite material were sampled, one sheet every 20 m from the first 200 m sample produced, and the sheets were evaluated. From the next 200 m sample, a total of 10 sheets of the composite material (width 200 mm×250 mm) were cold-pressed to form molded articles, one sheet every 20 m, and the molded articles were used for the tensile test. Samples for drape measurements and test samples for transportability of the heated composite material were taken from the remaining composite material.

Table 1 shows the evaluation results. In Example 1, since the widening of the carbon fiber bundle was fixed with the fixing agent, the coefficient of variation CVi_{A2} of Vfi_{A2} was small as shown in Table 1.

### Examples 2-3

Composite materials were produced in the same manner as in Example 1, except that the amounts of the fixing agent 1 and the fixing agent 2 were changed as shown in Table 1. Table 1 shows the results.

### Example 4

A composite material was produced in the same manner as in Example 2, except that the carbon fiber “Tenax” (registered trademark) STS40-24K manufactured by Teijin Limited was used as the carbon fiber and the widening width was set to 20 mm. Table 1 shows the results.

### Example 5

A composite material was prepared in the same manner as in Example 1, except that the fixing agent 1 was not used and the fixing agent 4 instead of the fixing agent 2 was coated on an undersurface of the carbon fiber using a kiss touch roll (rotation speed: 40 rpm) so that the solid content of the fixing agent 4 is 0.5 wt % (solid content) with respect to the carbon fiber. Observation of the produced carbon fiber bundle revealed that the fixing agent 4 coated on the undersurface had permeated the upper surface of the carbon fiber bundle.

### Example 6

A composite material was prepared in the same manner as Example 5 except that the fixing agent 4 was coated on the undersurface of the carbon fiber so that the amount of adhesion of the fixing agent 4 was 1 wt % (solid content) with respect to the carbon fiber by setting the rotational frequency of the kiss touch roll to 120 rpm. Observation of the produced carbon fiber bundle revealed that the fixing agent 4 coated on the undersurface had permeated the upper surface of the carbon fiber bundle. This means that the fixing agent 4 permeates the entire carbon fiber bundle, unlike Comparative Example 2 described later.

### Comparative Example 1

A composite material was produced in the same manner as in Example 1, except that the composite material was produced without using a fixing agent. Table 2 shows the results.

As in Example 1, when cutting the carbon fiber, the air flow was not constant and was disturbed over time. In Comparative Example 1, since no fixing agent was used, the coefficient of variation CVi_{A2} of Vfi_{A2} increased as shown in Table 2.

### Comparative Example 2

A composite material was produced in the same manner as in Example 2, except that the fixing agent 1 was not used and only the fixing agent 2 was used. Table 2 shows the results. Since the rotational frequency of the kiss touch roll was set to 20 rpm, the weight ratio of the fixing agent 2 to the carbon fibers was the same as in Example 6, but the fixing agent 2 was unevenly distributed on the lower surface of the carbon fiber bundle.

### Comparative Example 3

A composite material was produced in the same manner as in Example 1 except that 2 wt % of the fixing agent 3 was adhered to the carbon fibers by electrostatic coating without using the fixing agents 1 and 2. Table 2 shows the results.

### Comparative Example 4

Carbon fiber strand was widened so that a micrometer measurement value of the thickness of the carbon fiber strand was of 70 μm by passing plural carbon fibers “Tenax” (registered trademark) STS40-24K manufactured by Teijin Limited through a heating bar at 200° C. and winding the carbon fibers on a paper tube to obtain a widened strand of carbon fiber. Plural strands obtained by widening the obtained carbon fibers were arranged in parallel in one direction, and an amount of a nylon 6 resin film (“Emblem ON-25” manufactured by Unitika Ltd., melting point 220° C.) used was adjusted such that the carbon fiber volume fraction (Vfₜₒₜₐₗ) was 35%, and heat press treatment was performed to obtain a unidirectional sheet-like material.

After that, the obtained unidirectional sheet-like material was slit so that the fiber bundle width was target width of 2 mm. That is, the fiber bundle width was targeted for a fixed width (constant width) of 2 mm. After that, the silt material was cut so that the fiber bundle length was a fixed length of 20 mm to create a chopped strand prepreg using a guillotine type cutting machine. The chopped strand prepreg was placed on a steel belt conveyor so that the fibers were randomly oriented with a predetermined basis weight. Thereby a composite material precursor was obtained.

The carbon fibers contained in the chopped strands are designed to have a carbon fiber length of 20 mm, a carbon fiber bundle width of 2 mm, and a carbon fiber bundle thickness of 70 μm (target values). A predetermined number of the obtained composite material precursors were laminated in a flat plate mold of 350 mm square, and heated at 2.0 MPa for 20 minutes in a pressing device heated to 260° C. to produce a composite material having an average thickness of 2.0 mm. This composite material is pressed and is also a molded article. This operation was repeated 21 times to obtain 21 sheets of composite material sample. The first 10 sheets were burned off and used for fiber bundle analysis. The next 10 sheets were used for tensile testing and the last sheet was used as a sample for drape measurement. In addition, in order to prepare a test sample of the transportability of the heated composite material, a composite material of 100 mm×1500 mm was also prepared in a flat plate mold separately. Table 2 shows the results.

[Example 7] A thermoplastic resin assembly was prepared using a feeder and nylon 6 resin A1030 (sometimes called PA6) manufactured by Unitika Co., Ltd. as a thermoplastic resin by spraying and fixing the thermoplastic resin onto an air-permeable support that continuously moved in one direction and was installed under the feeder.

As reinforcing fibers, the following two types were prepared.

(i) Glass fiber E-glass (RS 460 A-782 manufactured by Nittobo) was coated with fixing agent 4 on the bottom surface of the glass fiber using a kiss touch and the fixing agent 4 was dried so that solid content of the fixing agent 4 is 1 wt % with respect to the glass fiber. As a result, a so-called multifilament glass fiber was prepared in which glass filaments were bonded together.
(ii) Glass fiber E-glass (RS 460 A-782 manufactured by Nittobo) was prepared without coating with fixing agent. Thus, a so-called single filament glass fiber was prepared.

Using a slitting device shown in FIG. 4, the multifilament of (i) was separated by pressing the multifilament against a rubber roll to slit the multifilament with a fiber width of 1 mm as a target. The separated multifilament of (i) and the single filaments of (ii) were cut to a fixed length of 20 mm using a rotary cutter with a volume ratio of 2:1.

The cut filaments were dispersed and fixed on a thermoplastic resin aggregate prepared in advance on an air-permeable support that was installed directly below the rotary cutter and that had a suction mechanism at the bottom and continuously moved in one direction, to obtain a glass fiber aggregate. The supply amount of glass fibers was set so that the volume fraction of glass fibers to the composite material was 35% and the average thickness of the composite material was 2.0 mm.

When the rotary cutter was used to cut the glass fiber to a fixed length of 20 mm, the glass fiber peeled off the roll by the negative pressure generated in the air stream. The composite composition was produced with a width of 200 mm and a length of 1000 m (composite material production speed of 2 m/min), and the air flow at this time was not constant and was turbulent over time.

A composite composition including the glass fiber aggregate and the thermoplastic resin aggregate was heated in a continuous impregnation device to impregnate the glass fibers with the thermoplastic resin and then cooled.

A total of 10 sheets of composite material were sampled, one sheet every 20 m from the first 200 m sample produced, and the sheets were evaluated. From the next 200 m sample, a total of 10 sheets of the composite material (width 200 mm×250 mm) were cold-pressed to form molded articles, one sheet every 20 m, and the molded articles were used for the tensile test. Samples for drape measurements and test samples for transportability of the heated composite material were taken from the remaining composite material.

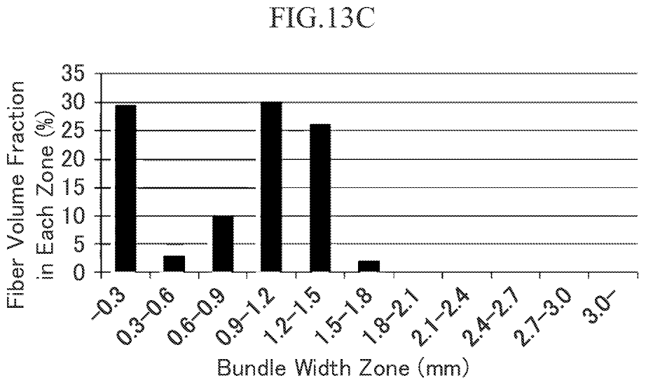

Tables 4-1 and 4-2 shows the evaluation results. FIGS. 13A to 13C describe distributions of fiber widths of Example 7, in which the fiber width distribution is partially missing.

### [Evaluation of Bulk Height Measurement]

Relations between evaluation of bulk height measurement and Vf (i=1 to 9)_{A2} value of each bundle width zone of reinforcing fiber A2 of Example 1, Example 5, Example 6, Comparative Example 1, and Comparative Example 4 are shown in Table 3. Since Vf of Examples 5 and 6 are higher in the bundle width zones of Vf (i=5)_{A2} and Vf (i=6)_{A2} than in the other bundle width zones, the fiber bundles are concentrated in these zones compared to Example 1. As a result, the bulk height measurement evaluation (coefficient of determination) is higher in Examples 5 and 6 than in Example 1.

TABLE 1

| | | Example 1 | Example 2 | Example 3 | Example 4 | Example 5 | Example 6 |
|---|---|---|---|---|---|---|---|
| Various materials | | | | | | | |
| Resin | | PA6 | PA6 | PA6 | PA6 | PA6 | PA6 |
| Reinforcing fiber | | STS40-48K | STS40-48K | STS40-48K | STS40-24K | STS40-48K | STS40-48K |
| Fiber length | | 20 mm | 20 mm | 20 mm | 20 mm | 20 mm | 20 mm |
| Vfₜₒₜₐₗ | | 35% | 35% | 35% | 35% | 35% | 35% |
| Fixing agent top surface | | Fixing | Fixing | Fixing | Fixing | — | — |
| | | agent 1 | agent 1 | agent 1 | agent 1 | | |
| Weight Percentage | Weight ratio | 3 | 3 | 8 | 3 | — | — |
| | to carbon | | | | | | |
| | fiber wt% | | | | | | |
| Fixing agent bottom surface | | Fixing | Fixing | Fixing | Fixing | Fixing | Fixing |
| | | agent 2 | agent 2 | agent 2 | agent 2 | agent 4 | agent 4 |
| Weight Percentage | Weight ratio | 0.5 | 1 | 2 | 1 | 0.5 | 1 |
| | to carbon | | | | | | |
| | fiber wt% | | | | | | |
| Composite manufacturing process | | | | | | | |
| First step of fixative | | hot | hot | hot | hot | — | — |
| application | | applicator | applicator | applicator | applicator | | |
| Second step of fixative | | kiss | kiss | kiss | kiss | kiss | kiss |
| application | | touch | touch | touch | touch | touch | touch |
| Kiss touch roll | rpm | 5 | 20 | 80 | 20 | 40 | 120 |
| rotation speed | | | | | | | |
| Solid content concentration of | | 20% | 20% | 20% | 20% | 10% | 10% |
| Fixing agent applied with kiss | | | | | | | |
| touch roll | | | | | | | |
| Analysis of composite materials | | | | | | | |
| Reinforcement fiber A1 | | | | | | | |
| Fiber volume fraction of | | 10% | 6% | 3% | 4% | 9% | 2% |
| reinforcing fiber A1 (Vf_{A1}) | | | | | | | |
| CV_{A1} | Bundle | 32% | 23% | 18% | 22% | 23% | 20% |
| | width <0.3 mm | | | | | | |
| Reinforcing fiber A2 | | | | | | | |
| Fiber volume fraction | | 24% | 22% | 20% | 22% | 25% | 30% |
| (Vf_{A2 (Total)}) | | | | | | | |
| CV1_{A2} | 0.3 mm ≤ bundle | 27% | 14% | 2% | 11% | 15% | 8% |
| | width < 0.6 mm | | | | | | |
| CV2_{A2} | 0.6 mm ≤ bundle | 26% | 17% | 8% | 13% | 17% | 7% |
| | width < 0.9 mm | | | | | | |
| CV3 _{A2} | 0.9 mm ≤ bundle | 18% | 11% | 5% | 9% | 11% | 5% |
| | width < 1.2 mm | | | | | | |
| CV4_{A2} | 1.2 mm ≤ bundle | 18% | 24% | 8% | 23% | 25% | 3% |
| | width < 1.5 mm | | | | | | |
| CV5_{A2} | 1.5 mm ≤ bundle | 11% | 16% | 3% | 9% | 15% | 12% |
| | width < 1.8 mm | | | | | | |
| CV6_{A2} | 1.8 mm ≤ bundle | 36% | 3% | 3% | 10% | 4% | 10% |
| | width < 2.1 mm | | | | | | |
| CV7_{A2} | 2.1 mm ≤ bundle | 25% | 16% | 12% | 10% | 15% | 5% |
| | width < 2.4 mm | | | | | | |
| CV8_{A2} | 2.4 mm ≤ bundle | 33% | 30% | 9% | 25% | 31% | 9% |
| | width < 2.7 mm | | | | | | |
| CV9_{A2} | 2.7 mm ≤ bundle | 30% | 21% | 8% | 16% | 20% | 6% |
| | width ≤ 3.0 mm | | | | | | |
| Reinforcing fiber bundle A3 | | | | | | | |
| Fiber volume fraction (Vf_{A3}) | | 1% | 7% | 9% | 8% | 1% | 3% |
| Coefficient of variation CVi of | | 5% | 23% | 5% | 3% | 18% | 5% |
| reinforcing fiber A3_{A3} | | | | | | | |
| Evaluation | | | | | | | |
| Springback amount | | 3.7 | 3.5 | 2.5 | 2.7 | 3.3 | 2.7 |
| Drapability when the | | Good | Good | Excellent | Excellent | Perfect | Perfect |
| composite material | | | | | | | |
| is heated | | | | | | | |
| Impregnation | Tensile strength | 8% | 6% | 3% | 3% | 5% | 4% |
| unevenness | CV value | | | | | | |

| | | | | | | |
|---|---|---|---|---|---|---|
| Transportability when | Excellent | Good | Good | Good | Excellent | Good |
| heating composite | | | | | | |
| materials | | | | | | |

TABLE 2

| | | Comparative | Comparative | Comparative | Comparative |
|---|---|---|---|---|---|
| | | example 1 | example 2 | example 3 | example 4 |
| Various materials | | | | | |
| Resin | | PA6 | PA6 | PA6 | PA6 |
| Reinforcing fiber | | STS40-48K | STS40-48K | STS40-48K | STS40-24K |
| Fiber length | | 20 mm | 20 mm | 20 mm | 20 mm |
| Vfₜₒₜₐₗ | | 35% | 35% | 35% | 35% |
| Fixing agent top surface | | — | — | Fixing agent | — |
| | | | | 3 | |
| Weight percentage | Weight ratio to | — | — | 2 | — |
| | carbon fiber | | | | |
| | wt % | | | | |
| Fixing agent bottom surface | | — | Fixing agent | | — |
| | | | 2 | | |
| Weight percentage | Weight ratio to | — | 1 | — | — |
| | carbon fiber | | | | |
| | wt % | | | | |
| Composite manufacturing process | | | | | |
| First step of fixative application | | — | — | electrostatic | — |
| | | | | coating | |
| Second step of fixative application | | — | kiss touch | — | — |
| Kiss touch roll | rpm | | 20 | | |
| rotation speed | | | | | |

| | | | |
|---|---|---|---|
| Solid content concentration of Fixing | 20% | — | — |
| agent applied with kiss touch roll | | | |

| | | Comparative | Comparative | Comparative | Comparative |
|---|---|---|---|---|---|
| | | example 1 | example 2 | example 3 | example 4 |
| Analysis of composite materials | | | | | |
| Reinforcement fiber A1 | | | | | |
| Fiber volume fraction of reinforcing fiber A1 | | 13% | 12% | 14% | 1% |
| (Vf_{A1}) | | | | | |
| CV_{A1} | Bundle width < 0.3 mm | 40% | 35% | 35% | 5% |
| Reinforcing fiber A2 | | | | | |
| Fiber volume fraction (Vf_{A2 (total)}) | | 21% | 19% | 19% | 34.0% |
| CV1_{A2} | 0.3 mm ≤ bundle width < 0.6 | 39% | 25% | 37% | — |
| | mm | | | | |
| CV2_{A2} | 0.6 mm ≤ bundle width < 0.9 | 35% | 27% | 30% | — |
| | mm | | | | |
| CV3_{A2} | 0.9 mm ≤ bundle width < 1.2 | 24% | 19% | 32% | — |
| | mm | | | | |
| CV4_{A2} | 1.2 mm ≤ bundle width < 1.5 | 11% | 23% | 25% | — |
| | mm | | | | |
| CV5_{A2} | 1.5 mm ≤ bundle width < 1.8 | 6% | 6% | 10% | — |
| | mm | | | | |
| CV6_{A2} | 1.8 mm ≤ bundle width < 2.1 | 69% | 42% | 65% | 1% |
| | mm | | | | |
| CV7_{A2} | 2.1 mm ≤ bundle width < 2.4 | 66% | 45% | 73% | — |
| | mm | | | | |
| CV8_{A2} | 2.4 mm ≤ bundle width < 2.7 | 64% | 60% | 75% | — |
| | mm | | | | |
| CV9_{A2} | 2.7 mm ≤ bundle width ≤ 3.0 | 70% | 50% | 80% | — |
| | mm | | | | |
| Reinforcing fiber bundle A3 | | | | | |
| Fiber volume fraction (Vf_{A3}) | | 1% | 4% | 2% | 0% |
| Coefficient of variation CVi of reinforcing | | 43% | 40% | 39% | 0% |
| fiber A3_{A3} | | | | | |
| Evaluation | | | | | |
| Springback amount | | 5.4 | 4 | 4.3 | 2 |
| Drapability when the composite material is | | Bad | Bad | Bad | Excellent |
| heated | | | | | |
| Impregnation | Tensile strength CV value | 15% | 13% | 13% | 3% |
| unevenness | | | | | |

| | | | | |
|---|---|---|---|---|
| Transportability when heating composite | Excellent | Excellent | Excellent | Bad |
| materials | | | | |

TABLE 3

| | | | | |
|---|---|---|---|---|
| | | | Comparative | Comparative |
| Example 1 | Example 5 | Example 6 | example 1 | example 4 |

Analysis of composite materials
Reinforcing fiber A2

| V f | 0.3 mm ≤ bundle | 1.8% | 1.2% | 0.5% | 10.5% | 0.0% |
|---|---|---|---|---|---|---|
| (i = 1)_{A2} | width < 0.6 mm | | | | | |
| V f | 0.6 mm ≤ bundle | 2.8% | 1.2% | 0.5% | 3.5% | 0.0% |
| (i = 2)_{A2} | width < 0.9 mm | | | | | |
| V f | 0.9 mm ≤ bundle | 2.5% | 0.7% | 0.5% | 1.8% | 0.0% |
| (i = 3)_{A2} | width < 1.2 mm | | | | | |
| V f | 1.2 mm ≤ bundle | 3.9% | 0.9% | 0.4% | 1.1% | 0.0% |
| (i = 4)_{A2} | width < 1.5 mm | | | | | |
| V f | 1.5 mm ≤ bundle | 4.6% | 14.2% | 16.3% | 0.7% | 0.0% |
| (i = 5)_{A2} | width < 1.8 mm | | | | | |
| V f | 1.8 mm ≤ bundle | 2.8% | 5.3% | 7.0% | 0.1% | 34.0% |
| (i = 6)_{A2} | width < 2.1 mm | | | | | |
| V f | 2.1 mm ≤ bundle | 3.5% | 0.7% | 2.8% | 1.0% | 0.0% |
| (i = 7)_{A2} | width < 2.4 mm | | | | | |
| V f | 2.4 mm ≤ bundle | 1.4% | 0.7% | 1.8% | 1.0% | 0.0% |
| (i = 8)_{A2} | width < 2.7 mm | | | | | |
| V f | 2.7 mm ≤ bundle | 0.7% | 0.4% | 0.7% | 1.0% | 0.0% |
| (i = 9)_{A2} | width ≤ 3.0 mm | | | | | |
| V f (i = 1)_{A2} + V f (i = 2)_{A2} | | 5% | 2% | 1% | 14% | 0% |
| V f (i = 8)_{A2} + V f (i = 9)_{A2} | | 2% | 1% | 2% | 2% | 0% |
| V f (i = 3)_{A2} + V f (i = 4)_{A2} + V f | | 17% | 22% | 27% | 5% | 34% |
| (i = 5)_{A2} + V f (i = 6)_{A2} + V f | | | | | | |
| (i = 7)_{A2} | | | | | | |
| Evaluation | Bulk height | Good | Excellent | Excellent | Bad | Excellent |
| | measurement | | | | | |

TABLE 4-1

| Various materials | | Example 7 |
|---|---|---|
| Resin | | PA6 |
| Reinforcing fiber (i) | | Glass fiber E-glass RS 460 A-782 |
| | | manufactured by Nittobo |
| Fixing agent | | Fixing agent 4 |
| Weight ratio of | Weight percentage | 1 |
| fixing agent | wt % to glass fiber | |

| | |
|---|---|
| Application of fixative | kiss touch |
| Fiber length | 20 mm |
| Reinforcing fiber (ii) | Glass fiber E-glass RS 460 A-782 |
| | manufactured by Nittobo |
| Fixing agent | None |
| Fiber length | 20 mm |
| Vfₜₒₜₐₗ | 35% |

TABLE 4-2

| | | Example 7 |
|---|---|---|
| Analysis of composite materials | | |
| Reinforcement fiber A1 | | |
| Fiber volume fraction of reinforcing fiber A1 (Vf_{A1}) | | 29% |
| CV_{A1} | bundle width < 0.3 mm | 3% |
| Reinforcing fiber A2 | | |
| Fiber volume fraction (Vf_{A2} (total)) | | 71% |
| CV1_{A2} | 0.3 mm ≤ bundle width < 0.6 mm | 25% |
| CV2_{A2} | 0.6 mm ≤ bundle width < 0.9 mm | 36% |
| CV3_{A2} | 0.9 mm ≤ bundle width < 1.2 mm | 7% |
| CV4_{A2} | 1.2 mm ≤ bundle width < 1.5 mm | 11% |
| CV5_{A2} | 1.5 mm ≤ bundle width < 1.8 mm | 46% |
| CV6_{A2} | 1.8 mm ≤ bundle width < 2.1 mm | 173% |
| CV7_{A2} | 2.1 mm ≤ bundle width < 2.4 mm | 0% |
| CV8_{A2} | 2.4 mm ≤ bundle width < 2.7 mm | 0% |
| CV9_{A2} | 2.7 mm ≤ bundle width ≤ 3.0 mm | 0% |
| Reinforcing fiber bundle A3 | | |
| Fiber volume ratio (Vf_{A3}) | | 0% |
| Coefficient of variation CVi_{A3} of reinforcing fiber A3 | | — |
| Evaluation | | |
| Springback amount | | 2.9 |
| Drapability when the composite material is heated | | Excellent |
| Impregnation | Tensile strength CV value | 7% |
| unevenness | | |

| | |
|---|---|
| Dimensional stability of the cutting edge (circular) | Good |
| Transportability when heating composite materials | Excellent |

### INDUSTRIAL APPLICABILITY

The composite material of the present invention and the molded article obtained by molding the same can be used in any part where shock absorption is desired, such as various structural members, such as structural members of automobiles, various electrical products, frames and housings of machines. be done. Particularly preferably, it can be used as an automobile part.

Although the present invention has been described in detail and with reference to specific embodiments, it will be apparent to those skilled in the art that various changes and modifications can be made without departing from the spirit and scope of the invention.

This application is based on a Japanese patent application (Japanese Patent Application No. 2020-132326) filed on Aug. 4, 2020, the contents of which are incorporated herein by reference.

### REFERENCE SIGNS LIST

401, 503, 603, 804: reinforcing fiber bundles
402: blade
403: support roller (rubber roller)
501, 601: Upper rotary blade
502, 602: Lower rotary blade
504: cutting edge
505: the tip of the lower rotary blade
604: Upper blade provided for the upper rotating blade
605: Lower blade provided for the lower rotary blade
701: Unsplit reinforcing fiber bundle
702: Separated reinforcing fiber bundles
703, 802: rotary slitter
704: Line direction
801: Rotating blade (rotated by dotted rotating blade support)
803: Rotation direction of rotary slitter
901: Composite material before heating
902: Composite materials that are heated and sag under their own weight
1001 Composite material with a hole h0
1002 hole-forming member
1003 Lower mold
1004 Upper mold
1005 Distance between inner wall surface W0 of hole h0 of composite material and hole forming member
1006 molded article
1101 Composite material with hole h0 and hole h0-1
h0 a hole provided in a composite material
h0-1 A second hole other than hole h0, provided in composite material

1. A composite material comprising reinforcing fibers A and a matrix resin, wherein:
the reinforcing fibers A are discontinuous fibers having a fiber length of 5 mm or more;
the reinforcing fibers A comprise
reinforcing fibers A1 having a fiber width of less than 0.3 mm; and
reinforcing fiber bundles A2 having a bundle width of 0.3 mm or more and 3.0 mm or less,
when the reinforcing fiber bundles A2 are divided into a plurality of predetermined bundle width zones (the total number n of bundle width zones satisfies n≥3), and when the volume fraction of the reinforcing fiber bundles A2 in each bundle width zone is Vfi_{A2}, coefficient of variation CVi_{A2} of Vfi_{A2} is 35% or less in at least the minimum bundle width zone (i=1), and the maximum bundle width zone (i=n),
wherein the coefficient of variation CVi_{A2} of Vfi_{A2} is calculated by the formula (a):
coefficient of variation CVi_{A2}=100×standard deviation of Vfi_{A2}/average of Vfi_{A2} formula (a).

2. The composite material according to claim 1,
wherein the coefficients of variation CVi_{A2} of Vfi_{A2} in all bundle width zones (i=1, . . . , n) are 35% or less.

3. The composite material according to claim 1,
wherein the coefficient of variation CV_{A1} of Vf_{A1} is 35% or less, where Vf_{A1} is the volume fraction of the reinforcing fibers A1,
wherein the coefficient of variation CV_{A1} of Vf_{A1} is calculated by formula (b):
coefficient variation CV_{A1}=100×standard deviation of Vf_{A1}/average of Vf_{A1} formula (b).

4. The composite material according to claim 1,
wherein the reinforcing fibers A are carbon fibers.

5. The composite material according to claim 1,
wherein the matrix resin is a thermoplastic matrix resin.

6. The composite material according to claim 1,
wherein the matrix resin is a thermoplastic matrix resin, and
springback amount of the composite material is more than 1.0, wherein the spring back amount is a ratio of a thickness of the composite material after preheating to a thickness of the composite material before preheating, and
coefficient of variation CVs of springback amount is less than 35%, wherein the coefficient of variation CVs is calculated by the formula (c):
coefficient of variation CVs=100×standard deviation of springback amount/average of springback amount formula (c).

7. The composite material according to claim 1, comprising reinforcing fibers B having a fiber length of less than 5 mm.

8. A method for producing a molded article, comprising cold-pressing the composite material according to claim 1 to produce a molded article.

9. The composite material according to claim 1,
wherein the total number of bundle width zones n is 9, and
each bundle width zone is followings:

| | |
|---|---|
| bundle width zone (i = 1) | 0.3 mm ≤ bundle width < 0.6 mm |
| bundle width zone (i = 2) | 0.6 mm ≤ bundle width < 0.9 mm |
| bundle width zone (i = 3) | 0.9 mm ≤ bundle width < 1.2 mm |
| bundle width zone (i = 4) | 1.2 mm ≤ bundle width < 1.5 mm |
| bundle width zone (i = 5) | 1.5 mm ≤ bundle width < 1.8 mm |
| bundle width zone (i = 6) | 1.8 mm ≤ bundle width < 2.1 mm |
| bundle width zone (i = 7) | 2.1 mm ≤ bundle width < 2.4 mm |
| bundle width zone (i = 8) | 2.4 mm ≤ bundle width < 2.7 mm |
| bundle width zone (i = 9) | 2.7 mm ≤ bundle width ≤ 3.0 mm. |

10. The composite material according to claim 9, wherein
the following formulas (x), (y) and (z) are satisfied, where Vfi_{A2} is the volume fraction of the reinforcing fiber bundles A2 in each bundle width zone.
0≤Vf(i=1)_{A2}<10% formula (x)
0<Vfi_{A2} is satisfied in two or more bundle width zones of i=2 to 9 formula (y)
Vf(i=1)_{A2}<Vf(i=at least one of 2 to 9)_{A2}. formula (z)
